(19) United States
(12) Patent Application Publication
(10) Pub. No.: US 2024/0267985 A1
(43) Pub. Date: Aug. 8, 2024

(54) METHOD AND APPARATUS FOR DISCONTINUOUS TRANSMISSION AND DISCONTINUOUS RECEPTION OPERATION

(71) Applicant: ELECTRONICS AND TELECOMMUNICATIONS RESEARCH INSTITUTE, Daejeon (KR)

(72) Inventors: Sung Hyun MOON, Daejeon (KR); Jung Hoon LEE, Daejeon (KR); Cheul Soon KIM, Daejeon (KR)

(73) Assignee: ELECTRONICS AND TELECOMMUNICATIONS RESEARCH INSTITUTE, Daejeon (KR)

(21) Appl. No.: 18/434,333

(22) Filed: Feb. 6, 2024

(30) Foreign Application Priority Data
Feb. 7, 2023 (KR) 10-2023-0016400
Mar. 8, 2023 (KR) 10-2023-0030733
Apr. 24, 2023 (KR) 10-2023-0053567
Jun. 1, 2023 (KR) 10-2023-0071019
Sep. 25, 2023 (KR) 10-2023-0128342
Oct. 12, 2023 (KR) 10-2023-0136259
Feb. 2, 2024 (KR) 10-2024-0016885

(51) Int. Cl. H04W 76/28

(52) U.S. Cl. CPC H04W 76/28

(57) ABSTRACT

Disclosed are methods and apparatuses for DTX and DRX operations. A method of a terminal may comprise: receiving cell DTX/DRX configuration information for serving cells including a first serving cell of a base station; receiving DCI including a first field from a second serving cell among the serving cells; entering a cell DTX inactive time in the first serving cell based on the first field; and skipping a reception operation of semi-persistent signals in the cell DTX inactive time of the first serving cell.

### CROSS-REFERENCE TO RELATED APPLICATIONS

This application claims priority to Korean Patent Applications No. 10-2023-0016400, filed on Feb. 7, 2023, No. 10-2023-0030733, filed on Mar. 8, 2023, No. 10-2023-0053567, filed on Apr. 24, 2023, No. 10-2023-0071019, filed on Jun. 1, 2023, No. 10-2023-0128342, filed on Sep. 25, 2023, No. 10-2023-0136259, filed on Oct. 12, 2023, and No. 10-2024-0016885, filed on Feb. 2, 2024, with the Korean Intellectual Property Office (KIPO), the entire contents of which are hereby incorporated by reference.

### BACKGROUND

### 1. Technical Field

The present disclosure relates to a technique for discontinuous transmission (DTX) and discontinuous reception (DRX), and more particularly, to a technique for DTX operations and DRX operations for increasing power efficiency of a network.

### 2. Related Art

The mobile communication systems can serve as a crucial infrastructure driving the advancement of the information and communications technology (ICT) industry. These systems are evolving to overcome the limitations and drawbacks of traditional communication schemes. They can provide advanced services in scenarios such as enhanced Mobile BroadBand (eMBB), Ultra Reliable Low Latency Communication (URLLC), massive Machine Type Communication (mMTC), ultra-low power, ultra-precision, and wide-area coverage. To achieve various performance metrics, new communication frequency bands are being explored in a mid-band and high-band, and multi-antenna technology is being more actively utilized.

The performance of communication and the processing capability of communication nodes can be increased, leading to a potential rise in power consumption of the communication nodes. Technologies to reduce power consumption not only at terminals but also in networks (such as base stations) are required for reducing operating costs for communication operators and for global carbon neutrality efforts.

### SUMMARY

Exemplary embodiments of the present disclosure are directed to providing a method and an apparatus for DTX operations and/or DRX operations in a communication system.

A method of a terminal, according to exemplary embodiments of the present disclosure for achieving the above-described objective, may comprise: receiving cell discontinuous transmission (DTX)/discontinuous reception (DRX) configuration information for serving cells including a first serving cell of a base station; receiving downlink control information (DCI) including a first field from a second serving cell among the serving cells; entering a cell DTX inactive time in the first serving cell based on the first field; and skipping a reception operation of semi-persistent signals in the cell DTX inactive time of the first serving cell.

The method may further comprise: entering a cell DRX inactive time in the first serving cell based on the first field, wherein a time of entering the cell DRX inactive time may be equal to a time of entering the cell DTX inactive time.

The time of entering the cell DTX inactive time may be determined by a timer, and the timer may operate periodically based on an information element included in the cell DTX/DRX configuration information.

The time of entering the cell DRX inactive time may be determined by a timer, and the timer may operate periodically based on an information element included in the cell DTX/DRX configuration information.

The semi-persistent signals may include a channel state information-reference signal (CSI-RS), and a CSI measurement operation for the CSI-RS may be excluded in the cell DTX inactive time.

CSI that is a result of the CSI measurement operation may include at least a rank indicator (RI).

The method may further comprise: skipping a transmission operation of semi-persistent signals in the cell DRX inactive time, wherein the semi-persistent signals may include at least a configured grant-physical uplink shared channel (CG-PUSCH).

The first field may belong to an information block configured for the terminal, and a start location of the information block mapped to a payload of the DCI may be configured to the terminal in a granularity of 1 bit.

The DCI may further include information indicating to enter a cell DTX inactive time for another serving cell other than the first serving cell among the serving cells, and the another serving cell may belong to a same cell group as the first serving cell.

The second serving cell may be a primary cell of the terminal.

A method of a base station, according to exemplary embodiments of the present disclosure for achieving the above-described objective, may comprise: transmitting cell discontinuous transmission (DTX)/discontinuous reception (DRX) configuration information for one or more serving cells to a terminal; transmitting downlink control information (DCI) including a first field to the terminal; and skipping a transmission operation of semi-persistent signals in a cell DTX inactive time according to the first field.

The method may further comprise: skipping a reception operation of semi-persistent signals in a cell DRX inactive time according to the first field, wherein a start time of the cell DRX inactive time may be equal to a start time of the cell DTX inactive time.

A start time of the cell DTX inactive time may be determined by a timer, and the timer may operate periodically based on an information element included in the cell DTX/DRX configuration information.

A start time of the cell DRX inactive time may be determined by a timer, and the timer may operate periodically based on an information element included in the cell DTX/DRX configuration information.

The semi-persistent signals may include a channel state information-reference signal (CSI-RS), and a CSI measurement operation for the CSI-RS may be excluded in the cell DTX inactive time.

The semi-persistent signals may include at least a configured grant-physical uplink shared channel (CG-PUSCH).

The first field may belong to an information block configured for the terminal, and a start location of the information block mapped to a payload of the DCI may be configured to the terminal in a granularity of 1 bit.

A terminal, according to exemplary embodiments of the present disclosure for achieving the above-described objective, may comprise: at least one processor, and the processor may cause the terminal to perform: receiving cell discontinuous transmission (DTX)/discontinuous reception (DRX) configuration information for serving cells including a first serving cell of a base station; receiving downlink control information (DCI) including a first field from a second serving cell among the serving cells; entering a cell DTX inactive time in the first serving cell based on the first field; and skipping a reception operation of semi-persistent signals in the cell DTX inactive time of the first serving cell.

The processor may further cause the terminal to perform: entering a cell DRX inactive time in the first serving cell based on the first field, wherein a time of entering the cell DRX inactive time may be equal to a time of entering the cell DTX inactive time.

The semi-persistent signals may include a channel state information-reference signal (CSI-RS), and a CSI measurement operation for the CSI-RS may be excluded in the cell DTX inactive time.

According to the present disclosure, a base station and a terminal can support cell DTX operations and/or cell DRX operations. The base station can transmit cell DTX/DRX configuration information to the terminal, and can transmit DCI to the terminal including information indicating cell DTX activation, cell DTX inactivation, cell DRX activation, and/or cell DRX inactivation. The terminal can enter an active period or inactive period according to the indication from the base station, and perform operations based on the active period or the inactive period.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of an apparatus.

FIG. 3 is a conceptual diagram illustrating a first exemplary embodiment of a DRX operation method of a terminal.

FIG. 4 is a conceptual diagram illustrating a first exemplary embodiment of a DTX operation method of a base station.

FIG. 5 is a conceptual diagram illustrating a first exemplary embodiment of a method for extending a cell DTX active time.

FIG. 6 is a conceptual diagram illustrating a first exemplary embodiment of a method for extending a cell DRX active time.

FIG. 7 is a conceptual diagram illustrating a first exemplary embodiment of a wake-up method of cell DTX and cell DRX.

FIG. 8 is a conceptual diagram illustrating a second exemplary embodiment of a wake-up method of cell DTX and cell DRX.

FIG. 9 is a conceptual diagram illustrating a first exemplary embodiment of a cell DTX inactivation indication method by (Method 100).

FIG. 10 is a conceptual diagram illustrating a first exemplary embodiment of a method for arranging cell DTX/DRX active times and terminal-specific DRX active times.

FIG. 11 is a conceptual diagram illustrating a first exemplary embodiment of a wake-up method of cell DTX and terminal-specific DRX.

FIG. 12 is a conceptual diagram illustrating a first exemplary embodiment of a PDSCH HARQ-ACK transmission method considering cell DRX operation.

FIG. 13 is a conceptual diagram illustrating a second exemplary embodiment of a PDSCH HARQ-ACK transmission method considering cell DRX operation.

FIG. 14 is a conceptual diagram illustrating a third exemplary embodiment of a PDSCH HARQ-ACK transmission method considering cell DRX operation.

FIG. 15 is a conceptual diagram illustrating a fourth exemplary embodiment of a PDSCH HARQ-ACK transmission method considering cell DRX operation.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, ‘configuration of an operation (e.g., transmission operation)’ may mean ‘signaling of configuration information (e.g., information element(s), parameter(s)) for the operation’ and/or ‘signaling of information indicating performing of the operation’. In other words, ‘an operation (e.g., transmission operation) being configured in a communication node’ may mean that the communication node receives ‘configuration information (e.g., information element, parameter) for the operation’ and/or ‘information indicating to perform the operation’. ‘An information element (e.g., parameter) being configured in a communication node’ may mean that the information element is signaled to the communication node (e.g., the communication node receives the information element)′. Signaling may be at least one of system information (SI) signaling (e.g., transmission of a system information block (SIB) and/or master information block (MIB)), RRC signaling (e.g., transmission of RRC parameters and/or higher layer parameters), MAC control element (CE) signaling, or PHY signaling (e.g., transmission of downlink control information (DCI), uplink control information (UCI), and/or sidelink control information (SCI)).

In the present disclosure, a ‘time’ may mean a time point, and ‘time’ and ‘time point’ may be used with the same meaning. A reception time of a signal or channel may mean a reception start time or a reception end time. A transmission time of a signal or channel may mean a transmission start time or a transmission end time.

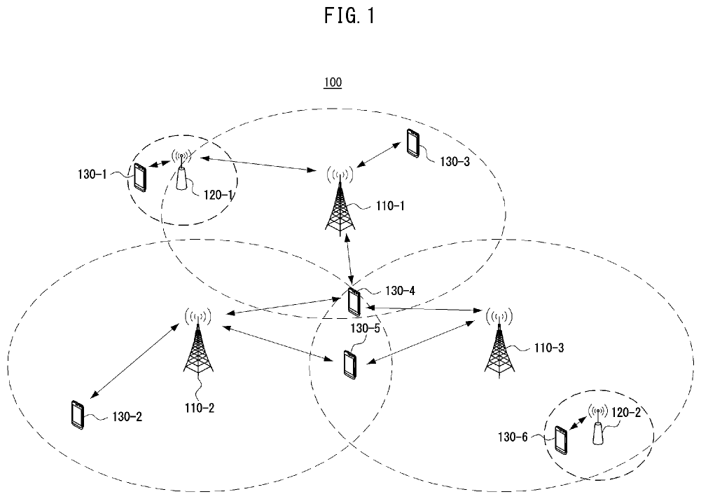

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g., a serving gateway (S-GW), a packet data network (PDN) gateway (P-GW), and a mobility management entity (MME)). When the communication system 100 is a 5G communication system (e.g., New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g., LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows.

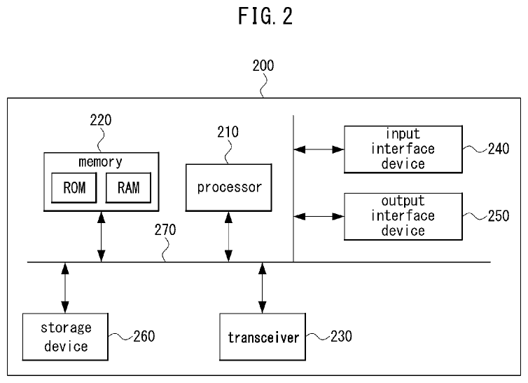

FIG. 2 is a block diagram illustrating a first exemplary embodiment of an apparatus.

Referring to FIG. 2, an apparatus 200 may comprise at least one processor 210, a memory 220, and a transceiver 230 connected to the network for performing communications. Also, the apparatus 200 may further comprise an input interface device 240, an output interface device 250, a storage device 260, and the like. The respective components included in the apparatus 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

The present disclosure relates to a discontinuous transmission (DTX) operation and/or discontinuous reception (DRX) operation in the communication system. To increase the power efficiency of the network (e.g., communication system), the base station may perform a DTX operation and/or a DRX operation, and the terminal may perform a DTX operation and/or a DRX operation corresponding to the operation of the base station. Exemplary embodiments of the present disclosure may be applied to communication systems (e.g., LTE communication system, 5G communication system (e.g., NR communication system), 6G communication system, etc.).

A numerology applied to physical signals and channels in the communication system (e.g., NR communication system or 6G communication system) may be variable. The numerology may vary to satisfy various technical requirements of the communication system. In the communication system to which a cyclic prefix (CP) based OFDM waveform technology is applied, the numerology may include a subcarrier spacing and a CP length (or CP type). Table 1 below may be a first exemplary embodiment of configuration of numerologies for the CP-based OFDM. The subcarrier spacings may have an exponential multiplication relationship of 2, and the CP length may be scaled at the same ratio as the OFDM symbol length. Depending on a frequency band in which the communication system operates, at least some numerologies among the numerologies of Table 1 may be supported. In addition, in the communication system, numerologies not listed in Table 1 may be further supported. CP type(s) not listed in Table 1 (e.g., extended CP) may be additionally supported for a specific subcarrier spacing (e.g., 60 kHz).

Table 1 relates to a first exemplary embodiment of a method for configuring numerologies for a CP-OFDM based communication system.

TABLE 1

| | Subcarrier spacing | | | | | |
|---|---|---|---|---|---|---|
| | 15 kHz | 30 kHz | 60 kHz | 120 kHz | 240 kHz | 480 kHz |
| OFDM symbol | 66.7 | 33.3 | 6.7 | 8.3 | 4.2 | 2.1 |
| length [μs] | | | | | | |
| CP length [μs] | 4.76 | 2.38 | 1.19 | 0.60 | 0.30 | 0.15 |
| Number of | 14 | 28 | 56 | 112 | 224 | 448 |
| OFDM symbols | | | | | | |
| within 1 ms | | | | | | |

In the following description, a frame structure in the communication system will be described. In the time domain, elements constituting a frame structure may include a subframe, slot, mini-slot, symbol, and the like. The subframe may be used as a unit for transmission, measurement, and the like, and the length of the subframe may have a fixed value (e.g., 1 ms) regardless of a subcarrier spacing. A slot may comprise consecutive symbols (e.g., 14 OFDM symbols). The length of the slot may be variable differently from the length of the subframe. For example, the length of the slot may be inversely proportional to the subcarrier spacing.

A slot may be used as a unit for transmission, measurement, scheduling, resource configuration, timing (e.g., scheduling timing, hybrid automatic repeat request (HARQ) timing, channel state information (CSI) measurement and reporting timing, etc.), and the like. The length of an actual time resource used for transmission, measurement, scheduling, resource configuration, etc. may not match the length of a slot. A mini-slot may include consecutive symbol(s), and the length of a mini-slot may be shorter than the length of a slot. A mini-slot may be used as a unit for transmission, measurement, scheduling, resource configuration, timing, and the like. A mini-slot (e.g., the length of a mini-slot, a mini-slot boundary, etc.) may be predefined in the technical specification. Alternatively, a mini-slot (e.g., the length of a mini-slot, a mini-slot boundary, etc.) may be configured (or indicated) to the terminal. When a specific condition is satisfied, use of a mini-slot may be configured (or indicated) to the terminal.

The base station may schedule a data channel (e.g., physical downlink shared channel (PDSCH), physical uplink shared channel (PUSCH), physical sidelink shared channel (PSSCH)) using some or all of symbols constituting a slot. In particular, for URLLC transmission, unlicensed band transmission, transmission in a situation where an NR communication system and an LTE communication system coexist, and multi-user scheduling based on analog beamforming, a data channel may be transmitted using a portion of a slot. In addition, the base station may schedule a data channel using a plurality of slots. In addition, the base station may schedule a data channel using at least one mini-slot.

In the frequency domain, elements constituting the frame structure may include a resource block (RB), subcarrier, and the like. One RB may include consecutive subcarriers (e.g., 12 subcarriers). The number of subcarriers constituting one RB may be constant regardless of a numerology. In this case, a bandwidth occupied by one RB may be proportional to a subcarrier spacing of a numerology. An RB may be used as a transmission and resource allocation unit for a data channel, control channel, and the like. Resource allocation of a data channel may be performed in units of RBs or RB groups (e.g., resource block group (RBG)). One RBG may include one or more consecutive RBs. Resource allocation of a control channel may be performed in units of control channel elements (CCEs). One CCE may include one or more RBs in the frequency domain.

In the communication system (e.g., NR communication system), the above-described unit time resource (hereinafter, ‘slot’) may be composed of a combination of one or more of downlink period, flexible period (or unknown period), and an uplink period. Each of a downlink period, flexible period, and uplink period may be comprised of one or more consecutive symbols. A flexible period may be located between a downlink period and an uplink period, between a first downlink period and a second downlink period, or between a first uplink period and a second uplink period. When a flexible period is inserted between a downlink period and an uplink period, the flexible period may be used as a guard period.

A slot may include one or more flexible periods. Alternatively, a slot may not include a flexible period. The terminal may perform a predefined operation in a flexible period. Alternatively, the terminal may perform an operation configured by the base station semi-statically or periodically. For example, the periodic operation configured by the base station may include a PDCCH monitoring operation, synchronization signal/physical broadcast channel (SS/PBCH) block reception and measurement operation, channel state information-reference signal (CSI-RS) reception and measurement operation, downlink semi-persistent scheduling (SPS) PDSCH reception operation, sounding reference signal (SRS) transmission operation, physical random access channel (PRACH) transmission operation, periodically-configured PUCCH transmission operation, PUSCH transmission operation according to a configured grant, and the like. A flexible symbol may be overridden by a downlink symbol or an uplink symbol. When a flexible symbol is overridden by a downlink or uplink symbol, the terminal may perform a new operation instead of the existing operation in the corresponding flexible symbol (e.g., overridden flexible symbol).

In the present disclosure, an SSB may refer to a signal set including synchronization signals and/or a broadcast channel. The synchronization signals may include a PSS, SSS, etc., and the broadcast channel may include a physical broadcast channel (PBCH). The SSB may further include a reference signal. Reference signals (e.g., reference signal included in the SSB) include a demodulation reference signal (DM-RS) for decoding of the PBCH, CSI-RS, tracking reference signal (TRS), positioning reference signal (PRS), phase tracking reference signal (PT-RS), and the like. In the NR communication system, the SSB may refer to a synchronization signal/physical broadcast channel (SS/PBCH) block. SSBs may be transmitted periodically, and one or more SSB(s) may be transmitted repeatedly in one cycle.

A format of the unit time resource (hereinafter, ‘slot format’) may be configured semi-statically by higher layer signaling (e.g., radio resource control (RRC) signaling). Information indicating a semi-static slot format may be included in system information, and the semi-static slot format may be configured in a cell-specific manner. In addition, a semi-static slot format may be additionally configured for each terminal through terminal-specific higher layer signaling (e.g., RRC signaling). A flexible symbol of a slot format configured cell-specifically may be overridden by a downlink symbol or an uplink symbol by terminal-specific higher layer signaling. In addition, a slot format may be dynamically indicated by physical layer signaling (e.g., slot format indicator (SFI) included in downlink control information (DCI)). The semi-statically configured slot format may be overridden by a dynamically indicated slot format. For example, a semi-static flexible symbol may be overridden by a downlink symbol or an uplink symbol by SFI.

The terminal may perform downlink operations, uplink operations, and sidelink operations in a bandwidth part. A bandwidth part may be defined as a set of consecutive RBs (e.g., physical resource blocks (PRBs)) having a specific numerology in the frequency domain. One numerology may be used for transmission of signals (e.g., transmission of control channel or data channel) in one bandwidth part. In the present disclosure, when used in a broad sense, a ‘signal’ may refer to any physical signal and channel. A terminal performing an initial access procedure may obtain configuration information of an initial bandwidth part from the base station through system information. A terminal operating in an RRC connected state may obtain the configuration information of the bandwidth part from the base station through terminal-specific higher layer signaling.

The configuration information of the bandwidth part may include a numerology and/or an RB set applied to the bandwidth part. At least one bandwidth part among the bandwidth part(s) configured in the terminal may be activated. For example, within one carrier, one uplink bandwidth part and one downlink bandwidth part may be activated respectively. In a time division duplex (TDD) based communication system, a pair of an uplink bandwidth part and a downlink bandwidth part may be activated. The base station may configure a plurality of bandwidth parts to the terminal within one carrier, and may switch the active bandwidth part of the terminal.

In exemplary embodiments, ‘a certain frequency band (e.g., carrier, bandwidth part, RB set, listen before talk (LBT) subband, guard band, etc.) is activated’ may mean that the base station or terminal is in a state where signals can be transmitted and received using the frequency band. Further, ‘a certain frequency band is activated’ may mean that a radio frequency (RF) filter (e.g., band-pass filter) of a transceiver is in a state of operating including the frequency band.

In exemplary embodiments, an RB may mean a common RB (CRB). Alternatively, an RB may mean a PRB or a virtual RB (VRB). In the communication system (e.g., NR communication system), a CRB may refer to an RB constituting a set of consecutive RBs (e.g., common RB grid) based on a reference frequency (e.g., point A). Carriers, bandwidth parts, and the like may be arranged on the common RB grid. In other words, a carrier, bandwidth part, etc. may be composed of CRB(s). An RB or CRB constituting a bandwidth part may be referred to as a PRB, and a CRB index within the bandwidth part may be appropriately converted into a PRB index. In an exemplary embodiment, an RB may refer to an interlace RB (IRB).

A PDCCH may be used to transmit a DCI or DCI format to the terminal. A minimum resource unit constituting a PDCCH may be a resource element group (REG). An REG may be composed of one PRB in the frequency domain and one OFDM symbol in the time domain. A demodulation reference signal (DMRS) for demodulating a PDCCH may be mapped to some REs among REs constituting the REG, and control information (e.g., modulated DCI) may be mapped to the remaining REs. One PDCCH candidate may be composed of one CCE or aggregated CCEs. One CCE may be composed of a plurality of REGs. The NR communication system may support CCE aggregation levels 1, 2, 4, 8, 16, and the like, and one CCE may consist of 6 REGs.

A control resource set (CORESET) may be a resource region in which the terminal performs a blind decoding on PDCCHs. The CORESET may be composed of a plurality of REGs. The CORESET may consist of one or more RBs in the frequency domain and one or more symbols (e.g., OFDM symbols) in the time domain. The symbols constituting one CORESET may be consecutive in the time domain. The RBs constituting one CORESET may be consecutive or non-consecutive in the frequency domain. One DCI (e.g., one DCI formation, one PDCCH) may be transmitted within one CORESET. A plurality of CORESETs may be configured with respect to a cell and a terminal, and time/frequency resource regions to which the plurality of CORESETs are mapped may or may not overlap with each other.

A CORESET may be configured in the terminal during an initial access procedure. For example, a CORESET may be configured in the terminal by an initial access signal (e.g., a PBCH or system information transmitted on the PBCH). An identifier (ID) of the CORESET configured by the initial access signal may be 0. The CORESET configured by the initial access signal may be referred to as a CORESET 0. A terminal operating in the RRC idle state may perform a monitoring operation in the CORESET 0 in order to receive an initial PDCCH in the initial access procedure. Not only terminals operating in the RRC idle state but also terminals operating in the RRC connected state may perform monitoring operations in the CORESET 0. The CORESET may be configured in the terminal by other system information (e.g., system information block type 1 (SIB1)) other than the system information transmitted through the initial access signal (e.g., PBCH). For example, for reception of a random access response (or Msg2), the terminal may receive the SIB1 including the configuration information of the CORESET. The CORESET may be configured in the terminal by terminal-specific higher layer signaling (e.g., RRC signaling).

A search space may be a set of candidate resource regions in which PDCCHs can be transmitted. The terminal may perform a blind decoding on each of PDCCH candidates within a predefined search space or a search space configured by the base station. The terminal may determine whether a PDCCH is transmitted to itself by performing a cyclic redundancy check (CRC) on a result of the blind decoding. When it is determined that a PDCCH is a PDCCH for the terminal itself, the terminal may receive the PDCCH.

One or more search space(s) may constitute a search space set. The search space may be defined/configured for each CCE aggregation level, and the search space set may mean a search space for each CCE aggregation level or a sum of search spaces for all CCE aggregation levels. For each CCE aggregation level, a PDCCH candidate may consist of CCE(s) selected by a predefined hash function within the CORESET or search space occasion. In exemplary embodiments, ‘search space set’ may refer to ‘search space’.

A search space set may be logically associated (e.g., combined) with one CORESET. One CORESET may be logically associated with one or more search space sets. A common search space set configured by the PBCH may be used to monitor a DCI that schedules a PDSCH for carrying the SIB1. An ID of the common search space set configured by the PBCH may be set to 0. In other words, the common search space set configured by the PBCH may be defined as a Type 0 PDCCH common search space set or search space set #0. The search space set #0 may be logically associated with the CORESET 0.

The search space sets may be classified into common search space sets and terminal-specific search space sets (i.e. UE-specific search space sets) depending on their purposes or operations of the terminal. A common DCI or a terminal-specific DCI (e.g., UE-specific DCI) may be transmitted in a common search space set, and a terminal-specific DCI may be transmitted in a terminal-specific search space set (e.g., UE-specific search space set). For example, the common DCI may include resource allocation information of a PDSCH including system information, paging messages, etc., power control command, slot format indicator (SFI), and/or preemption indicator. The terminal-specific DCI may include resource allocation information of a PDSCH and/or resource allocation information of a PUSCH. A plurality of DCI formats may be defined depending on the purposes, and the plurality of DCI formats may be distinguished by the terminal by a DCI payload, DCI field, DCI size, and/or radio network temporary identifier (RNTI).

In the present disclosure, a common search space may be referred to as a CSS, and a common search space set may be referred to as a CSS set. A terminal-specific search space may be referred to as a UE-specific search space (USS), and a terminal-specific search space set may be referred to as a USS set.

Meanwhile, the terminal's constant monitoring on downlink control channels (e.g., PDCCHs) regardless of presence or absence of traffic may cause unnecessary power consumption of the terminal. As a method to increase a battery life of the terminal, a discontinuous reception (DRX) operation may be performed in the terminal.

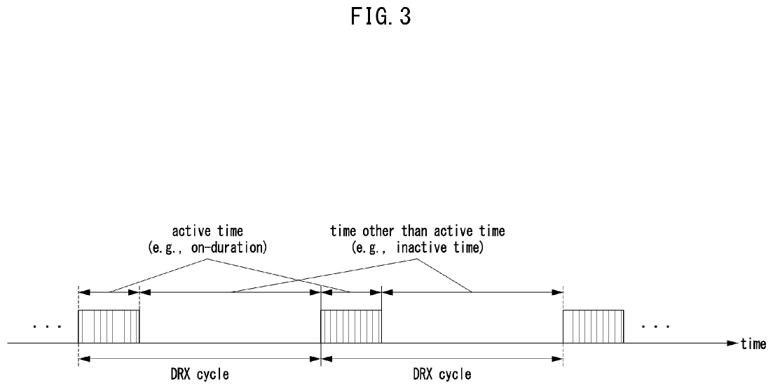

FIG. 3 is a conceptual diagram illustrating a first exemplary embodiment of a DRX operation method of a terminal.

Referring to FIG. 3, a base station may transmit DRX configuration information to a terminal. The terminal may receive the DRX configuration information from the base station. The terminal may configure a DRX cycle based on the DRX configuration information. The terminal may perform a PDCCH monitoring operation in an on-duration or active time configured at a starting part of each DRX cycle, and may skip the PDCCH monitoring operation in the remaining time period. The active time may be referred to as an on-duration, DRX on period, or the like, and a time period other than the active time may be referred to as a DRX off period, inactive time, DRX period, sleep period, or the like.

The active time (e.g., DRX active time) may include at least one of a time during which an on-duration timer operates or a time during which a DRX inactivity timer operates. The on-duration timer may be started at a start time of each DRX cycle. Alternatively, the on-duration timer may be started at a time later than the start time of each DRX cycle by a predetermined offset. In other words, a start time of the active time may coincide with the start time of the DRX cycle, or the start time of the active time may be later than the start time of the DRX cycle by a predetermined time offset. The terminal may consider a period from the start time of the on-duration timer to an expiration time of the on-duration timer as the active time. When the DRX inactivity timer is configured, the terminal may perform PDCCH monitoring during a predetermined time period from a time (e.g., slot, subframe, symbol) of successfully receiving a PDCCH. In other words, the DRX inactivity timer may be started or reset at a time (e.g., slot, subframe, symbol) when the terminal successfully receives the PDCCH. The terminal may consider a period from a start or reset time of the DRX inactivity timer to an expiration time of the DRX inactivity timer as the active time. The above-described timer may decrease by 1 for each reference time (e.g., slot, subframe, symbol group). The timer may expire at a time (e.g., slot, subframe, symbol group) when a value of the timer becomes 0. A symbol group may include one or more symbols.

According to the above-described operation, when the terminal successfully receives a PDCCH in an active time of a certain DRX cycle, the DRX inactivity timer of the terminal may be started, and the active time may be extended by starting the DRX inactivity timer. On the other hand, when a PDCCH is not received in an active time of a certain DRX cycle, the terminal may re-enter the DRX off state at an expiration time of the on-duration timer. For example, the terminal may consider a period in which at least one of the on-duration timer and the DRX inactivity timer operates as the active time. The terminal may receive a medium access control (MAC) control element (CE) from the base station, and the MAC CE may indicate the terminal to enter a DRX off period. Information indicating to enter the DRX off period may be a DRX inactivation indication. In this case, the terminal may switch its operation mode to the DRX off mode regardless of a value of the operating timer. In this case, the on-duration timer and DRX inactivity timer may be stopped. The above-described terms such as ‘on-duration timer’ and ‘DRX inactivity timer’ are merely examples, and may be replaced with other terms to express the corresponding timer operation.

The DRX operations may include a DRX operation using a long DRX cycle (hereinafter referred to as ‘long DRX operation’) and a DRX operation using a short DRX cycle (hereinafter referred to as ‘short DRX operation’). Among the long DRX operation and the short DRX operation, only one DRX operation may be performed. Alternatively, the long DRX operation and the short DRX operation may be performed in combination. The above-described operation may be performed every DRX cycle. The above-described operation may be applied to terminals in the RRC connected state. The DRX operation performed by terminals in the RRC connected sate may be referred to as connected-DRX (C-DRX). Alternatively, the above-described operation may be applied to terminals in the RRC idle state or RRC inactive (or non-active) state. The DRX operation performed by terminals in the RRC idle state or RRC inactive state may be referred to as idle DRX. The above-described operation may be applied to a base station, serving cell, TRP, etc.

### [Cell DTX/DRX Operation Method]

Low-power operation techniques of the network may be considered as a way to increase energy efficiency of the communication system. A network (e.g., base station) may periodically or opportunistically enter a sleep mode in which it does not perform transmission or reception operations. In the sleep mode, the network may operate in a low-power mode, and the power consumption of the network may be reduced. The above-described operation may be referred to as a DTX or DRX operation of the base station.

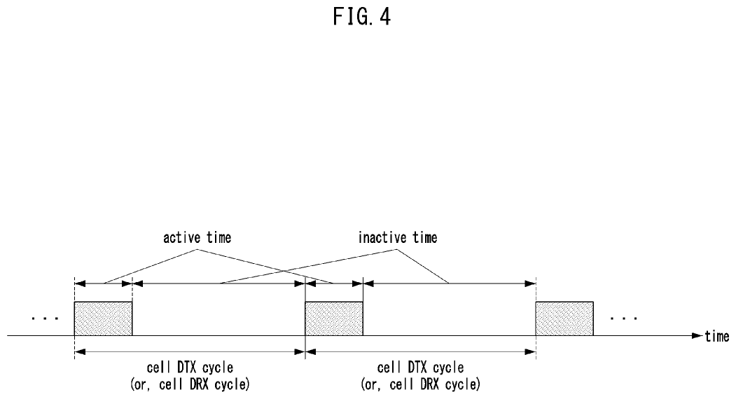

FIG. 4 is a conceptual diagram illustrating a first exemplary embodiment of a DTX operation method of a base station.

Referring to FIG. 4, a base station may periodically perform a DTX operation. The base station may perform a signal transmission operation in a DTX active time and may not perform a signal transmission operation in a DTX inactive time. In general, the base station may perform a transmission operation for a first signal set in a DTX active time, and may perform a transmission operation for a second signal set in a DTX inactive time. Each signal set may include physical signal(s) and/or channel(s). The second signal set may be included in the first signal set. For example, the first signal set may include all downlink signal(s) and/or all channel(s) transmitted from the base station to a terminal. For example, the second signal set may be an empty set. In other words, the base station may not perform transmission operations or may perform only limited transmission operations in the DTX inactive time. Accordingly, the base station may operate in a low-power mode in the DTX inactive time. For convenience, the above-described DTX operation of the base station may be referred to as a cell DTX operation. In addition to the base station, a communication node such as a serving cell, carrier, and TRP may be an entity that performs the cell DTX operation.

In a similar manner, the base station may periodically perform a DRX operation. The base station may perform a signal reception operation in a DRX active time and may not perform a signal reception operation in a DRX inactive time. Alternatively, the base station may perform a reception operation for a third signal set in a DRX active time and may perform a reception operation for a fourth signal set in a DRX inactive time. Each signal set may include physical signal(s) and/or channel(s). The fourth signal set may be included in the third signal set. For example, the third signal set may include all uplink signal(s) and/or all channel(s) that the base station receives from a terminal. For example, the fourth signal set may be an empty set. In other words, the base station may not perform reception operations or may perform only limited reception operations in the DRX inactive time. Accordingly, the base station may operate in a low-power mode in the DRX inactive time. For convenience, the above-described DRX operation of the base station may be referred to as a cell DRX operation. In addition to the base station, a communication node such as a serving cell, carrier, and TRP may be an entity that performs the cell DRX operation.

The cell DTX/DRX operation of the base station may be performed regardless of transmission and reception operations of the terminal. In the present disclosure, a cell DTX/DRX operation may refer to a cell DTX operation and/or a cell DRX operation. For example, in a cell DTX inactive time, the base station may not transmit a periodically-configured downlink signal to the terminal, the terminal may still expect to receive the downlink signal, and the terminal may perform a reception operation of the downlink signal. For another example, in a cell DRX inactive time, the terminal may transmit a periodically-configured uplink signal, and the base station may not receive the uplink signal even though the uplink signal is transmitted. However, the above-described method may deteriorate signal measurement and/or transmission performance and may increase power consumption of the terminal unnecessarily.

Therefore, while the base station is performing the cell DTX/DRX operation, it may be preferable for the terminal to also perform an operation corresponding to the operation of the base station. To support the above-described operation, the base station may transmit cell DTX/DRX configuration information to the terminal. In the present disclosure, the cell DTX/DRX configuration information may refer to cell DTX configuration information and/or cell DRX configuration information. The cell DTX/DRX configuration information may be cell DTX/DRX configuration information for one or more cells of the base station. The cell DTX/DRX configuration information may be transmitted from a first serving cell of the base station. The first serving cell may be a primary cell of the base station. Alternatively, the first serving cell may not be a primary cell of the base station. The cell DTX/DRX configuration information may include at least one of a DTX/DRX cycle (or DTX/DRX cycle value), location of active time, or length of active time. The DTX/DRX cycle may refer to a DTX cycle and/or DRX cycle. The cell DTX/DRX configuration information may be transmitted to the terminal through higher layer signaling (e.g., RRC signaling).

The terminal may receive the cell DTX/DRX configuration information from the base station (e.g., the first cell of the base station). The terminal may configure a cell DTX cycle based on the cell DTX/DRX configuration information (e.g., cell DTX configuration information). The terminal may perform a signal reception operation in a cell DTX active time, and may not perform a signal reception operation in a cell DTX inactive time. Alternatively, the terminal may perform a reception operation for a first signal set in a cell DTX active time, and may perform a reception operation for a second signal set in a cell DTX inactive time. In addition, the terminal may perform a signal blind decoding operation (e.g., PDCCH monitoring operation) in a cell DTX active time, and may not perform a signal blind decoding operation (e.g., PDCCH monitoring operation) for at least some signals in a cell DTX inactive time. Similarly, the terminal may configure a cell DRX cycle based on the cell DTX/DRX configuration information (e.g., cell DRX configuration information). The terminal may perform a signal transmission operation in a cell DRX active time, and may not perform a signal transmission operation in a cell DRX inactive time. Alternatively, the terminal may perform a transmission operation for a third signal set in a cell DRX active time and may perform a transmission operation for a fourth signal set in a cell DRX inactive time.

The above-described operation may be commonly applied to a plurality of terminals that communicate with the base station. In other words, a terminal operation corresponding to the cell DTX/DRX operation (e.g., cell DTX operation and/or cell DRX operation) may be performed by a terminal group belonging to a serving cell. The terminal group may include all terminals belonging to the serving cell. Alternatively, the terminal group may include some terminals belonging to the serving cell. For example, the some terminals may be terminals located in the same transmission/reception beam direction of the base station. A plurality of terminals may receive common (e.g., the same) cell DTX/DRX configuration information from the base station, and may configure at least one of a common (e.g., the same) DTX/DRX cycle, active time, or inactive time.

The cell DTX operation may correspond to a DRX operation of a terminal or a DRX operation of a terminal group. The cell DRX operation may correspond to a DTX operation of a terminal or a DTX operation of a terminal group. When described from the terminal perspective, ‘cell DRX’ may be referred to as ‘group DTX’. To distinguish from the terminal-specific DRX operation described in the exemplary embodiment of FIG. 3, ‘cell DTX’ may be referred to as ‘group DRX’. In the present disclosure, ‘a terminal performs a cell DTX operation or a cell DRX operation’ may mean that the terminal performs a group DRX operation corresponding to the cell DTX operation or a group DTX operation corresponding to the cell DRX operation.

Referring to FIG. 4, the cell DTX active time may be arranged at a starting part of each cell DTX cycle. The terminal may perform a signal reception operation and/or a blind decoding operation in periodically repeated active times. In this case, the cell DTX active time may be opportunistically extended in a specific cell DTX cycle.

The cell DTX active time may be extended terminal-specifically. In other words, among a plurality of terminals performing the cell DTX operation, a terminal that satisfies a predetermined condition may extend the cell DTX active time. For example, the terminal may extend the active time if it successfully receives a DCI (e.g., PDCCH) in the active time. The DCI may be a DCI that schedules a PDSCH. Alternatively, the DCI may be a DCI indicating to receive another downlink signal (e.g., CSI-RS, TRS, PRS, etc.). The active time may be extended at least as long as the terminal can sufficiently receive the downlink signal. The operation of extending the active time may be performed based on a timer. If the terminal successfully receives a DCI (e.g., PDCCH) in the active time, the terminal may start or reset a timer based on a reception time of the DCI. The terminal may enter an inactive time when the timer expires. The timer may be counted (e.g., the value of the timer is decreased) every unit time (e.g., every slot, every subframe), and the timer may expire when it has a certain value (e.g., 0). Alternatively, the operation of extending the active time of the terminal may be explicitly indicated by the DCI. In this case, the DCI may include at least one of information indicating to extend the active time, information on an extended time of the active time, or information on a time of entering an inactive time. The DCI may be transmitted by a second cell among the serving cells of the base station, and the indication of the DCI transmitted by the second cell may be applied to the second cell and/or other cells. The second cell may be a primary cell of the base station. Alternatively, the second cell may not be a primary cell of the base station.

The terminal may perform the same downlink reception operation in the extended active time as in an active time corresponding to an on-duration. For example, the terminal may perform a PDCCH monitoring operation on search space sets in the extended active time. The search space sets may include arbitrary types of search space sets (e.g., Type 0/0A/1/2 CSS set, Type 3 CSS set, USS set). The terminal may monitor arbitrary types of DCI formats (e.g., DCI format with a CRC scrambled by a C-RNTI, CS-RNTI, MCS-C-RNTI, etc.) in the search space sets. Downlink reference signals (e.g., CSI-RS, TRS, PRS) configured periodically or semi-persistently may be received in the extended active time. A signal configured periodically may be referred to as a periodic signal, and a signal configured semi-persistently may be referred to as a semi-persistent signal.

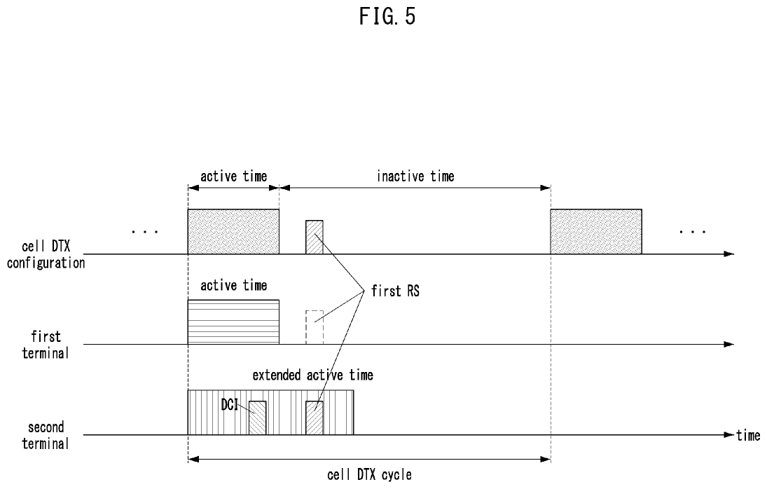

FIG. 5 is a conceptual diagram illustrating a first exemplary embodiment of a method for extending a cell DTX active time.

Referring to FIG. 5, a first terminal and a second terminal belonging to the same serving cell may receive cell DTX configuration information from a base station and perform cell DTX operations based on the cell DTX configuration information. In this case, the second terminal may receive a DCI within an active time, and may extend the active time by the above-described method based on the received DCI. On the other hand, the first terminal may not extend an active time. In other words, an end time of a cell DTX active time or a time of entering a cell DTX inactive time may be terminal-specific.

A first reference signal (e.g., first RS) may be configured for the first terminal and the second terminal. For example, the first reference signal may include at least one of CSI-RS, TRS, or PRS. The first reference signal may be configured to the terminals periodically or semi-persistently. In the exemplary embodiment of FIG. 5, the first reference signal may be transmitted in a period corresponding to the extended active time of the second terminal. Accordingly, the second terminal may receive the first reference signal. On the other hand, the first reference signal may be transmitted in an inactive time of the first terminal, and the first terminal may not receive the first reference signal depending on an operation in the inactive time. The first terminal that does not receive the first reference signal and/or the first terminal that does not extend the active time may not be conducive to the power efficiency of the base station. Rather, the first terminal that does not receive the first reference signal and/or the first terminal that does not extend the active time may degrade performance of downlink measurements (e.g., RRM measurement, RLM measurement, CSI measurement, beam quality measurement, etc.) of the first terminal. Hereinafter, exemplary embodiments for solving the above-described problems will be described.

The cell DTX active time may be extended commonly for a terminal group. In other words, a plurality of terminals performing the cell DTX operation (e.g., a plurality of terminals belonging to the terminal group) may commonly extend the cell DTX active time in a specific cell DTX cycle. For example, the plurality of terminals may receive the same DCI and extend the active time based on the received DCI. The DCI may be a group common DCI transmitted to the plurality of terminals. Specifically, the terminals (e.g., terminal group receiving the DCI) may start or reset a timer operating in the active time based on reception of the DCI. Alternatively, the terminals may extend the timer operating in the active time based on reception of the DCI. As a result, the cell DTX active time may be extended.

In an explicit manner, the terminals (e.g., terminal group receiving the DCI) may selectively perform one of an operation to enter an inactive time and an operation to maintain the active time based on reception of the DCI. The DCI may include information indicating the operation to enter an inactive time (e.g., inactivation indication information) or information indicating the operation to maintain the active time (e.g., activation indication information or activation maintenance information). The one operation may be applied at least within a cell DTX cycle in which the DCI is received. For example, the one operation may be applied to the remaining time period excluding an on-duration within the cell DTX cycle. When performing the operation to enter an inactive time, the terminal may enter an inactive time from an end time of a preconfigured active time, an end time of an active time indicated by the DCI, or a start time of the inactive time, and may not receive downlink signals or may perform limited reception in the inactive time. Alternatively, the terminal may enter an inactive time after a predetermined time from a time of receiving the DCI. The inactive time may last until an active time of the next cell DTX cycle starts. When performing the operation to maintain the active time, the terminal may consider the entire remaining time in the corresponding cell DTX cycle as the active time, and may perform a reception operation in the active time. The above-described operation may be applied to a plurality of cell DTX cycles. The number of DTX cycles to which the above-described operation is applied may be dynamically signaled by the DCI. Alternatively, the number of DTX cycles to which the above-described operation is applied may be configured to the terminal by higher layer signaling (e.g., MAC CE, RRC signaling). The above-described operation may be performed without relying on a timer (e.g., timer configured for the cell DTX operation or cell DRX operation). The DCI may include at least one of information indicating to enter an inactive time or information indicating to maintain the active time.

In order to maximize a sleep time of the base station, the operation to enter an inactive time or the operation to maintain the active time may be commonly applied to all terminals receiving the DCI. In other words, the DCI may include one field corresponding to the indication information (e.g., indication on the operation to enter an inactive time or the operation to maintain the active time), and terminal(s) that receive the DCI may equally perform an same operation of identifying the one field. The one field may include information commonly indicated to all terminals receiving the DCI.

On the other hand, considering the power efficiency of individual terminals, the operation to enter an inactive time or the operation to maintain the active time may be individually indicated to a plurality of terminals receiving the DCI. In other words, the DCI may include A fields or A blocks each corresponding to the indication information (e.g., indication on the operation to enter an inactive time or the operation to maintain the active time). A may be a natural number. When the DCI includes A blocks, each of the A blocks may include one or more field(s). Each of the A fields or A blocks may include indication information for each terminal or each terminal subgroup receiving the DCI. A terminal may receive information indicating one field or block among the A fields or the A blocks from the base station, and may interpret bit(s) or code point(s) corresponding to the one field or block to perform a cell DTX operation corresponding to the bit(s) or codepoint(s). The information indicating the one field or block may include information indicating a location (e.g., location of the first bit) to which the bit(s) corresponding to the one field or block are mapped within a payload of the DCI.

In the above-described method, a time period determined as the active time or inactive time according to the indication of the DCI may be the same for all terminals receiving the DCI. Alternatively, a time period determined as the active time or inactive time according to the indication of the DCI may be different among the plurality of terminals receiving the DCI. The time period may be configured independently for each terminal through higher layer signaling (e.g., RRC signaling). Additionally or alternatively to the above-described exemplary embodiment, the time period may be indicated differently to the plurality of terminals based on different fields or different blocks of the DCI.

The terminal (e.g., terminal group receiving the DCI) may determine a time of entering an inactive time based on reception of the DCI, and enter the inactive time at the determined time. The above-described operation may be applied at least within a cell DTX cycle in which the DCI is received. The DCI may include information on the time of entering the inactive time (e.g., time offset, slot offset). Alternatively, the information on the time of entering the inactive time (e.g., time offset, slot offset) may be configured to the terminal by higher layer signaling (e.g., RRC signaling). Alternatively, a plurality of candidate times of entering the inactive time (e.g., candidate time offsets, candidate slot offsets) may be configured to the terminal, and one of the plurality of candidate times may be indicated to the terminal by a DCI. According to this method, the base station may extend the cell DTX active time as intended with one DCI transmission.

In the above-described exemplary embodiment, the DCI transmitted to the plurality of terminals may be configured in two stages. For example, scheduling information for the terminal may be included in the DCI, and the DCI may be transmitted to the terminal in two stages. The first stage DCI may include group common information, and the first stage DCI may be transmitted to the plurality of terminals. The second stage DCI may include control information for specific terminal(s), and the second stage DCI may be transmitted to the specific terminal(s). In the above-described exemplary embodiment, the DCI transmitted to the plurality of terminals may be the first stage DCI. The group common information included in the first stage DCI may include information indicating the terminal to enter an inactive time or information indicating the terminal to maintain the active time. The information indicating the terminal to enter an inactive time may be inactivation indication information, and the information indicating the terminal to maintain the active time may be activation indication information. The first terminal and the second terminal may commonly receive the first stage DCI and extend the active time based on the first stage DCI. The second terminal may additionally receive the second stage DCI and transmit and receive a data channel based on scheduling information included in the second stage DCI.

In the above-described exemplary embodiment, the terminal may consider a time of cell DRX also to be activated in the extended cell DTX active time (e.g., slots corresponding to the extended active time). In general, the terminal may extend a cell DRX active time in cell DRX or cell DRX cycle(s) associated with the cell DTX or cell DTX cycle. In other words, the terminal may extend both the cell DTX active time and the cell DRX active time based on the DCI. The terminal may perform the same uplink transmission operation in the period (e.g., extended active time) as in the cell DRX active time. For example, the terminal may transmit an uplink reference signal (e.g., SRS) configured periodically or semi-persistently in the period (e.g., extended active time).

Similarly to the cell DTX, a cell DRX active time may be arranged at a starting part of each cell DRX cycle. The cell DRX cycle may be a cell DRX cycle included in the cell DRX configuration information, and the cell DRX cycle may be configured independently from the cell DTX cycle. The terminal may perform signal transmission operations in periodically repeated active times. The base station may perform signal reception operations and/or signal blind decoding operations in the active times. The target signals for which the base station performs blind decoding may include at least one of PRACH, PUCCH, CG PUSCH, or SRS. In this case, the cell DRX active time may be opportunistically extended in a specific cell DRX cycle.

A specific method of extending a cell DRX active time may be the same as or similar to the above-described method of extending a cell DTX active time. According to an exemplary embodiment, a cell DRX active time may be terminal-specifically extended based on whether a DCI (e.g., uplink scheduling DCI) is received, whether a data channel (e.g., PUSCH) is scheduled, or the like. According to another exemplary embodiment, a cell DRX active time may be extended commonly for a terminal group. Terminal(s) (e.g., terminal group) may receive a DCI (e.g., group common DCI) and extend a cell DRX active time based on indication information of the received DCI. The terminal may consider at least part of a time period (e.g., the remaining time period excluding an on-duration, off-duration, etc.) belonging to cell DRX cycle(s) including a reception time of the DCI or cell DRX cycle(s) that are not later than the reception time of the DCI as an active time or inactive time, according to the indication of the DCI.

The above-described operations may be performed based on a timer. The cell DTX active time and the cell DRX active time may be managed by a common timer. For example, the cell DTX active time and the cell DRX active time may be determined by a common on-duration timer. A time period in which the common on-duration timer operates may be considered as the cell DTX active time and/or cell DRX active time. Additionally or alternatively to the above-described exemplary embodiment, a timer that determines the cell DRX active time may be configured to the terminal separately from a timer that determines the cell DTX active time, and the timer that determines the cell DRX active time and the timer that determines the cell DTX active time may be operated individually. The above-described operation may be performed in a specific cell DRX cycle.

Information indicating whether to enter a cell DTX inactive time and information indicating whether to enter a cell DRX inactive time may be included in the same DCI (e.g., the same group common DCI), and the same DCI may be transmitted to the same terminal (or terminal group). For example, each field or each block within the group common DCI may include both the information indicating whether to enter a cell DTX inactive time and the information indicating whether to enter a cell DRX inactive time. The information indicating whether to enter a cell DTX inactive time and the information indicating whether to enter a cell DRX inactive time may be independent of each other. Alternatively, at least part of the information indicating whether to enter a cell DTX inactive time and the information indicating whether to enter a cell DRX inactive time may be information commonly applied to cell DTX and cell DRX. The information indicating whether to enter a cell DTX inactive time may include a cell DTX inactivation indication or cell DTX activation indication. The information indicating whether to enter a cell DRX inactive time may include a cell DRX inactivation indication or cell DRX activation indication.

A resource in which the terminal receives the DCI or a resource scheduled through the DCI (e.g., PDSCH resource, PUSCH resource, CSI-RS resource, SRS resource, PUCCH resource, etc.) may belong to the cell DTX inactive time or the cell DRX inactive time. In this case, the terminal may switch to a cell DTX active time or cell DRX active time based on reception of the DCI. A time of switching to the active time may be determined based on a time of receiving the DCI. For example, if the DCI is received in a slot n, the terminal may switch to the active time in a slot n+N. Each of n and N may be an integer. For another example, the cell DTX operation or cell DRX operation of the terminal may be switched to an active operation from a slot to which the scheduled resource belongs. The DCI may include not only a DCI that indicates the terminal to wake up, but also another DCI (e.g., scheduling DCI). In the present disclosure, an active operation may be performed in an active period, and an inactive operation may be performed in an inactive period. In other words, the active operation may refer to a DTX operation, DRX operation, cell DTX operation, and/or cell DRX operation in the active period. The inactive operation may refer to a DTX operation, DRX operation, cell DTX operation, and/or cell DRX operation in the inactive period.

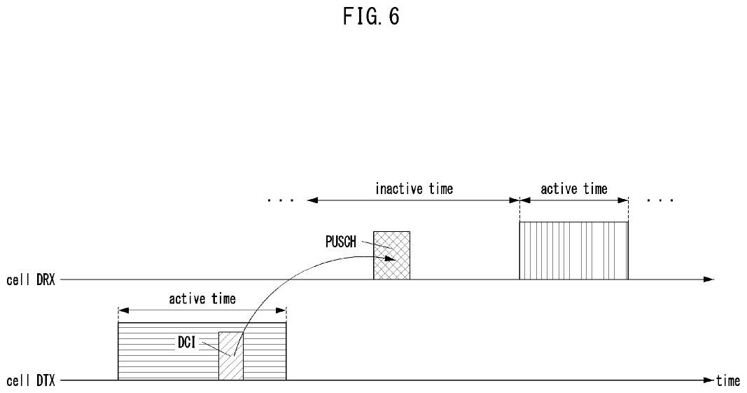

FIG. 6 is a conceptual diagram illustrating a first exemplary embodiment of a method for extending a cell DRX active time.

Referring to FIG. 6, a terminal may perform a cell DRX operation. In a cell DRX inactive time (e.g., a period outside an on-duration, off-duration, etc.), a PUSCH may be dynamically scheduled to the terminal. A DCI scheduling the PUSCH may be transmitted in a cell DTX active time of the terminal and/or a cell DRX active time of the terminal. The terminal may extend the cell DRX active time by the method described above. The terminal may regard at least a unit time resource (e.g., symbol(s), slot, subslot, subframe, ms) to which a resource to which the PUSCH is allocated belongs as a cell DRX active time. In other words, the cell DRX operation may be switched from an inactive operation to an active operation in the unit time resource. In this case, the cell DRX operation may be switched back to the inactive operation after the unit time resource. Alternatively, the cell DRX operation may be maintained as the active operation even after the unit time resource until an event such as a separate indication or timer expiration occurs. As another method of determining a time of switching to the active time (e.g., active operation), the terminal may determine a time (e.g., slot) after a predetermined time elapses from a time of receiving the DCI scheduling the PUSCH as a time of switching to the active time. In the extended active time, the terminal may transmit the PUSCH. In the extended active time, the terminal may additionally transmit other uplink signals (e.g., periodic SRS, semi-persistent SRS, PUCCH, PUCCH including SR).

Alternatively, the terminal may not expect to receive dynamic scheduling for an uplink resource in a cell DRX inactive time (e.g., period outside an active time). The uplink resource may include a resource such as PUSCH, SRS, and PUCCH. When a DCI scheduling an uplink resource in the cell DRX inactive time is received, the terminal may ignore all indication information in the DCI and may not perform operations corresponding to all the indication information. Alternatively, when a DCI scheduling an uplink resource in a cell DRX inactive time is received, the terminal may skip an operation of transmitting a signal scheduled in the uplink resource, and the terminal may normally perform an operation based on other control information included in the DCI.

As another method, when dynamic scheduling indicating to transmit a signal in a first resource belonging to a cell DRX inactive time is received, the terminal may determine a second resource to replace the first resource, and may transmit the signal in the determined second resource. The second resource may be a resource belonging to an active time (e.g., on-duration). For example, the second resource may be a resource belonging to the earliest slot (or subslot, subframe, ms) included in an active time (e.g., on-duration) among resources after a slot (or subslot, subframe, ms) to which the first resource belongs.

When the terminal extends a cell DRX active time or switches the cell DRX operation to the active operation by dynamic scheduling, the terminal may extend the cell DTX active time or switch the cell DTX operation to the active operation in addition to the above-described exemplary embodiment. For example, the terminal may consider a period corresponding to the extended cell DRX active time as a cell DTX active time, and perform a PDCCH monitoring operation in the period (e.g., active time). According to the above-described operation, the terminal may additionally monitor an uplink scheduling DCI after receiving scheduling information of an uplink signal, and expect additional uplink scheduling.

As another method, the terminal may still consider the unit time resource (e.g., symbol(s), slot, subslot, subframe, ms) to which the PUSCH resource is allocated as an inactive time, and transmit the PUSCH in the period (e.g., inactive time) exceptionally. The terminal may additionally transmit other uplink signals (e.g., periodic SRS, semi-persistent SRS, PUCCH, PUCCH including SR) in addition to the PUSCH in the period (e.g., inactive time). The terminal may receive configuration information of a resource of a PUCCH (e.g., periodic PUCCH) including UCI (e.g., HARQ-ACK and/or CSI) in the period. The PUCCH may be mapped to the same slot (or the same subslot) as the PUSCH. In this case, the UCI (e.g., HARQ-ACK and/or CSI) may be transmitted to the base station along with the PUSCH in the slot.

The above-described method may be applied identically or similarly to an operation of extending a cell DTX active time. The terminal may receive dynamic scheduling of a PDSCH in a cell DTX inactive time, and may consider a unit time resource (e.g., symbol(s), slot, subslot, subframe, ms) to which a resource of the PDSCH belongs as a DTX active time. In the extended active time, the terminal may receive the PDSCH. In the extended active time, the terminal may additionally receive other downlink signals (e.g., CSI-RS, TRS, PRS, PDCCH, etc.) in addition to the PDSCH. Alternatively, the terminal may not expect to receive dynamic scheduling of a downlink resource (e.g., PDSCH, CSI-RS, TRS, PRS, PDCCH, etc.) in a cell DTX inactive time. Alternatively, when dynamic scheduling of a PDSCH is received in a cell DTX inactive time, the terminal may receive the PDSCH in another resource (e.g., resource belonging to an active time or on-duration) replacing a resource to which the PDSCH is allocated. Alternatively, the terminal may still consider a unit time resource (e.g., symbol(s), slot, subslot, subframe, ms) to which the PDSCH resource is allocated as an inactive time, and receive the PDSCH in the period (e.g., inactive time) exceptionally. The terminal may additionally receive other downlink signals (e.g., CSI-RS, TRS, PRS, PDCCH, etc.) in addition to the PDSCH in the period (e.g., inactive time).

The dynamically scheduled PUSCH (or dynamically scheduled PDSCH) considered in the above-described exemplary embodiment is merely an example, and the operations described through the above-described exemplary embodiment may be identically applied also to other dynamically scheduled uplink signals (or other downlink signals).

The above-described method may be applied identically to periodically transmitted signals in addition to dynamically scheduled resources. For example, SSB(s) may be transmitted periodically to the terminal. The terminal may consider a unit time resource (e.g., symbol(s), slot, subslot, subframe ms) to which an SSB resource belongs as an active time, and may receive the SSB in the period (e.g., active time). The terminal may additionally receive other downlink signals in addition to the SSB in the period (e.g., active time).

Meanwhile, in high-frequency band communication, SSBs may be repeatedly transmitted based on a plurality of beams. For example, L SSB resources may be arranged in each SSB cycle, and locations of the L SSB resources may be defined in technical specifications or configured to the terminal. The base station may select M SSB resources from among the L SSB resources, and may repeatedly transmit SSBs M times in the selected M SSB resources. Each of L and M may be a natural number, and M may be less than or equal to L In this case, different beams (e.g., transmission beams, transmission/reception beam pairs, reception beams, spatial quasi-co-location (QCL)) may be applied to the M repeatedly transmitted SSBs. The base station may inform the terminal of the selected M SSB resources through a signaling procedure, and the terminal may receive SSB(s) in the M SSB resources indicated by the base station.

According to the above-described method, the terminal may consider a unit time resource to which each of the M SSB resources belongs as an active time, and receive SSB(s) and/or other downlink signals in the active time. In this case, the terminal may not perform an SSB reception operation in (L-M) SSB resources that are not actually transmitted, and the (L-M) SSB resources may not affect the cell DTX operation of the terminal. When M is a large value, a time period switched to the active time by the SSBs may be relatively long, and downlink reception complexity at the terminal may increase. The terminal may only receive some SSBs among M SSBs. For example, the terminal may only receive one SSB per cycle. The one SSB may be selected by the terminal according to predetermined criteria during an initial access process. Alternatively, the one SSB may be an SSB reported from the terminal to the base station. The one SSB may be an SSB that provides the highest reception quality (e.g., RSRP, L1-RSRP, theoretical SINR). The terminal may consider a unit time resource to which the one SSB belongs as a cell DTX active time, and may receive the SSB and/or other downlink signals in the cell DTX active time. The remaining (L−1) or remaining (M−1) SSBs may not affect the cell DTX operation of the terminal. For example, a unit time resource to which the remaining (L−1) or remaining (M−1) SSBs belong may still be maintained as an inactive time or active time.

Meanwhile, operations of a plurality of terminals may be configured in a cell DTX (or cell DRX) inactive time. As a first method for the above-described operation, multiple cell DTX (or cell DRX) configurations may be configured to the terminal. Each cell DTX (or each cell DRX) configuration may have at least one of an operation cycle (e.g., terminal DRX (or DTX) operation cycle corresponding to the cell DTX (or cell DRX)) of an independent cell DTX (or independent cell DRX) or an active time occupation period. The terminal may perform a first operation in an inactive time according to a first cell DTX (or, first cell DRX) configuration, and may perform a second operation in an inactive time according to a second cell DTX (or second cell DRX) configuration. The operation cycle of the cell DTX (or cell DRX) may refer to a cell DTX (or cell DRX) cycle.

As a second method, multiple cell DTX (or cell DRX) operation modes may be configured to the terminal. The multiple cell DTX (or, cell DRX) operation modes may be configured by the same cell DTX (or cell DRX) configuration, and a common cell DTX (or common cell DRX) operation cycle may be applied to the multiple cell DTX (or cell DRX) operation modes. The multiple cell DTX (or cell DRX) operation modes may correspond to different reception operations (or transmission operations) of the terminals. For example, a terminal operating in a first cell DTX (or first cell DRX) operation mode may perform a first operation, and a terminal operating in a second cell DTX (or second cell DRX) operation mode may perform a second operation. The first operation or the second operation may be performed in an inactive time. The above-described cell DTX (or cell DRX) operation mode may also be defined in a cell DTX (or cell DRX) active time in a similar manner.

The first operation and the second operation may correspond to an operation of receiving the first signal set and an operation of receiving the second signal set according to the cell DTX, respectively. Alternatively, the first operation and the second operation may correspond to an operation of transmitting the third signal set and an operation of transmitting the fourth signal set according to the cell DRX, respectively. An inclusion relationship may be established between the first signal set and the second signal set. An inclusion relationship may be established between the third signal set and the fourth signal set. Certain signal set(s) may be empty set(s). Even if some signals are not included in the signal set, the some signals may be received or transmitted by the terminal. In downlink communication, the some signals may include at least one of SSB, PDCCH for paging or SIB transmission, PDSCH, or Msg2. In uplink communication, the some signals may include a PUCCH for transmission of at least one of PRACH or SR. The PRACH may be limited to a PRACH by a contention-based random access procedure.

Meanwhile, for periodic traffic transmission, the terminal may receive SPS PDSCH configuration information from the base station, and receive an SPS PDSCH based on the SPS PDSCH configuration information. The base station may configure one or a plurality of SPS configurations to the terminal depending on a situation. For example, in order to periodically transmit a plurality of traffic having at least one of different quality of service (QOS), different arrival times, or different arrival rates, a plurality of SPS configurations may be configured to the terminal. In this case, for example, some traffic with a small packet delay budget (PDB) may need to be continuously transmitted even while the base station performs a cell DTX operation (e.g., sleep mode operation). In other words, in a cell DTX inactive time, the terminal may receive or monitor only SPS resources for some SPS configuration(s) among the plurality of SPS configurations. For the above-described case, a method may be considered in which a signal set that the terminal receives (or does not receive) in the cell DTX inactive time partially includes SPS configuration(s) configured to the terminal. For example, each SPS configuration may be assigned a unique index, and the signal set may include index(es) of SPS configuration(s) associated with signal(s) and/or channel(s) that the terminal is to receive (or not to receive).

The above-described method may be equally applied to other signals and/or other channels. For example, the terminal may receive a plurality of CG configurations from the base station and transmit a CG PUSCH based on configuration information of each CG configuration. In this case, a signal set that the terminal transmits (or does not transmit) in a cell DRX inactive time may include index(es) of CG configuration(s) associated with signal(s) and/or channel(s) that the terminal is to transmit (or not to transmit). For another example, the terminal may receive a plurality of SR configurations from the base station, and transmit an SR based on configuration information of each SR configuration. The SR may be transmitted through a PUCCH resource formed based on the SR configuration information. In this case, a signal set that the terminal transmits (or does not transmit) in the cell DRX inactive time may include index(es) of SR configuration(s) associated with signal(s) and/or channel(s) that the terminal is to transmit (or not to transmit). For another example, the terminal may receive configuration information of a plurality of CSI-RS resources (or a plurality of CSI-RS resource sets, a plurality of CSI resource sets, etc.), and may receive some CSI-RS resource(s) (or some CSI-RS resource set(s), some CSI resource set(s)) among the plurality of CSI-RS resources (or the plurality of CSI-RS resource sets, the plurality of CSI resource sets, etc.) in the cell DTX inactive time according to the above-described method, and perform CSI measurement and reporting operations. Reception of a CSI-RS resource may refer to reception of a CSI-RS in the CSI-RS resource. For another example, the terminal may receive configuration information of a plurality of SRS resources (or a plurality of SRS resource sets), and transmit only some SRS resource(s) (or some SRS resource set(s)) among the plurality of SRS resources in the cell DRX inactive time. Transmission of an SRS resource may refer to transmission of an SRS in the SRS resource.

The above-described method may be equally applied to a dynamically scheduled signal and/or channel. For example, a signal set that the terminal receives (or does not receive) in a cell DTX inactive time may include only some CORESET(s) (e.g., CORESET ID(s) corresponding to the some CORESET(s)) among CORESETs configured in the terminal. The terminal may monitor (or may not monitor) search space set(s) (or PDCCH candidate(s), PDCCH monitoring occasion(s)) associated with the CORESET(s) included in the signal set. Alternatively, a signal set that the terminal receives (or does not receive) in a cell DTX inactive time may include some search space set(s) (e.g., search space set ID(s), search space set group ID, etc. corresponding to the some search space set(s)) among search space sets configured in the terminal. The terminal may transmit and receive (or may not transmit and receive) not only the search space set but also signals scheduled through the search space set (e.g., PDSCH, PUSCH, PUCCH, CSI-RS, SRS, etc.) in the cell DTX/DRX inactive time.

Regardless of whether a certain CORESET or search space set is included or not included in the signal set, the certain CORESET or search space set may be monitored by the terminal in the cell DTX inactive time. The certain CORESETs may include the CORESET 0. The certain search space sets may include CSS sets. For example, the certain search space sets may include at least one of a Type 0 CSS set, a Type 0A CSS set, a Type 1 CSS set, or a Type 2 CSS set. Even if a certain PDCCH candidate or DCI format is included or not included in the signal set, the certain PDCCH candidate or DCI format may be monitored by the terminal in the cell DTX inactive time. For example, the terminal may always monitor a DCI or DCI format with a CRC scrambled by SI-RNTI, P-RNTI, RA-RNTI, etc., regardless of the cell DTX inactive time.

A signal set for cell DTX and a signal set for cell DRX may be associated with each other. For example, a first signal set for cell DTX and a third signal set for cell DRX may be associated or connected to each other. The terminal may receive information indicating to receive the first signal set in a cell DTX inactive time (or cell DTX active time), and may transmit the third signal set associated with the first signal set in a cell DRX inactive time (or cell DRX active time) according to the indication. On the other hand, the terminal may receive information indicating to transmit the third signal set in a cell DRX inactive time (or cell DRX active time), and may receive the first signal set associated with the third signal set in a cell DTX inactive time (or cell DTX active time) according to the indication. Similarly, a cell DTX operation mode and a cell DRX operation mode may be associated with each other. When the terminal receives an indication of a cell DTX (or cell DRX) operation mode, the terminal may perform a cell DRX (or cell DTX) operation mode associated with the indicated operation mode in a cell DRX inactive time (or cell DRX active time).

The above-described transmission and reception operation of the terminal may be dynamically indicated by the above-described DCI. For example, the DCI may include at least one of information indicating to receive a specific signal set in a cell DTX inactive time or information indicating not to receive a specific signal set in a cell DTX inactive time. The DCI may include at least one of information indicating to transmit a specific signal set in a cell DRX inactive time or information indicating not to transmit a specific signal set in a cell DRX inactive time. For example, the information (e.g., information included in the DCI) may be expressed in at least one form of a cell DTX (or cell DRX) configuration index or a cell DTX (or cell DRX) operation mode (or a number and/or index corresponding to the cell DTX (or cell DRX) operation mode). In the above-described exemplary embodiment, the information may be included in the DCI indicating the terminal to extend a cell DTX (or cell DRX) active time, and the DCI may be transmitted to the terminal. The terminal may perform the indicated operation (e.g., operation indicated by the information included in the DCI) in the next cell DTX (or cell DRX) inactive time(s) (e.g., inactive time of the current cell DTX (or cell DRX) cycle and/or inactive time(s) of the next cell DTX (or cell DRX) cycle). In other words, a valid period of the indication may be determined based on a reception time of the DCI, and the valid period may include one or more cell DTX cycle(s) and/or cell DRX cycle(s) not earlier than the reception time of the DCI. The terminal may continuously perform the indicated operation in the cell DTX/DRX cycles following the indicated operation or inactive times of cell DTX/DRX cycles following the indicated operation until receiving an additional indication. The cell DTX operation mode and cell DRX operation mode may be indicated together by one DCI. Alternatively, the cell DTX operation mode and cell DRX operation mode may be indicated by respective DCIs.

As described above, the cell DTX/DRX operation may be periodically switched from the inactive operation to the active operation. A terminal (e.g., terminal group) performing the cell DTX/DRX operation may switch the cell DTX/DRX operation to an active operation at a start time of an active time (e.g., on-duration) of each cell DTX/DRX cycle. Meanwhile, it may be unnecessary for the base station to transmit a downlink signal to the terminal group in a certain cell DTX/DRX cycle. In this case, as a method to minimize unnecessary wake-up operations of the terminal, a method of dynamically indicating a cell DTX/DRX wake-up operation of the terminal may be considered. In the present disclosure, a wake-up operation (e.g., cell DTX/DRX wake-up operation) may refer to at least one of an operation of switching from a dormant state to a non-dormant state or an operation of switching from an inactive time to an active time.

A cell DTX/DRX wake-up operation of the terminal may be indicated to the terminal by DCI. For example, the base station may transmit a group common DCI to a terminal group performing the same cell DTX/DRX operation. The group common DCI may be transmitted by one cell (e.g., primary cell) of the base station. The group common DCI may include information indicating a cell DTX/DRX wake-up operation. In the NR communication system, the group common DCI may mean a DCI format 2_X. X may be an integer greater than or equal to 0. In the present disclosure, a DCI that indicates a wake-up operation (e.g., cell DTX/DRX wake-up operation) of a terminal or terminal group may be referred to as a wake-up DCI. The wake-up DCI may be transmitted by one cell (e.g., primary cell) of the base station. The wake-up DCI may include common wake-up indication information, and terminals that receive the wake-up DCI may perform the same wake-up operation based on the common wake-up indication information. According to the above-described method, a payload size of the wake-up DCI may be determined at a low level regardless of the number of terminals receiving the DCI, and the wake-up DCI may be successfully received by the terminal group with a very high probability.

The wake-up DCI may be transmitted in a search space set associated with one of CORESET(s) configured in the terminal. The configured CORESET(s) may be valid in both cell DTX active times and DTX inactive times. Alternatively, a separate CORESET may be configured in the terminal for PDCCH monitoring of the terminal in cell DTX inactive times. The wake-up DCI may be transmitted in a search space set associated with the separate CORESET. The separate CORESET and/or the search space set(s) corresponding to the separate CORESET may not be valid in the cell DTX active times. In other words, a PDCCH monitoring capability of the terminal in the cell DTX active times may be unrelated to the separate CORESET. For example, an operation of the terminal determining a valid search space set(s) for each unit time resource (e.g., slot) may be irrelevant to the separate CORESET and/or the search space set(s) corresponding to the separate CORESET. The valid search space set(s) may refer to search space set(s) in which the terminal is to perform a blind decoding operation. The wake-up DCI may be transmitted on a PDCCH, and a CRC of the PDCCH may be scrambled by an RNTI. The RNTI may be set to the same value for all terminals receiving the wake-up DCI.

The wake-up DCI may include at least one of information indicating to enter a cell DTX/DRX active time (e.g., cell DTX/DRX activation indication) or information indicating to maintain a cell DTX/DRX inactive time (e.g., cell DTX/DRX inactivation indication). The information (e.g., information included in the wake-up DCI) may be common to all terminals that receive the wake-up DCI. In other words, the wake-up DCI may include one piece of information indicating the operation or one field corresponding to the operation (e.g., indication of the operation). Alternatively, a plurality of indication information for a plurality of terminals may be included in the wake-up DCI. In this case, the wake-up DCI may include B independent fields or B independent blocks indicating the operations. B may be a natural number. When the wake-up DCI includes B independent blocks that indicate the operations, each block may include one or more field(s). The terminal may read one field or block for itself among the plurality of fields or blocks included in the wake-up DCI, and perform a cell DTX/DRX operation corresponding to the identified indication information. Information on a location of bit(s) or a bit string to which the one field or one block is mapped may be configured in advance to the terminal through RRC signaling.

The wake-up DCI may include information (e.g., time offset, slot offset, subframe offset, etc.) required to determine a time at which the terminal enters an active time (e.g., on-duration). The base station may dynamically determine the information (e.g., offset information) and instantaneously control a wake-up time of the terminal (e.g., terminal group) by transmitting the determined information to the terminal. Additionally or alternatively to the above-described exemplary embodiment, the wake-up DCI may include information on a length of a cell DTX/DRX on-duration. When the terminal wakes up in an on-duration of a certain cell DTX/DRX cycle, the terminal may determine the length of the on-duration (e.g., a time of entering an inactive time) based on the information on the length of the cell DTX/DRX on-duration. Accordingly, the location and/or length of the terminal's cell DTX/DRX active time may change dynamically for each cell DTX cycle. The location and/or length of the terminal's cell DTX/DRX active time may vary for each cell DTX cycle.

A reception operation (e.g., PDCCH monitoring operation) of the terminal in a cell DTX active time and/or a transmission operation of the terminal in a cell DRX active time may be dynamically indicated by the wake-up DCI. The wake-up DCI may include information indicating to receive a specific signal set in a cell DTX active time or information indicating not to receive a specific signal set in a cell DTX active time. The wake-up DCI may include information indicating to transmit a specific signal set in a cell DRX active time or information indicating not to transmit a specific signal set in a cell DRX active time. For example, the information (e.g., information included in the wake-up DCI) may be expressed in at least one form of a cell DTX (or cell DRX) configuration index or a cell DTX (or cell DRX) operation mode (or a number or index corresponding to the cell DTX (or cell DRX) operation mode). The wake-up DCI may further include information on a bandwidth part (or carrier) in which the terminal is to perform a reception operation in a cell DTX active time and/or information on a bandwidth part (or carrier) in which the terminal is to perform a transmission operation in a cell DRX active time.

A plurality of DCI formats may be defined for cell DTX wake-up indication and cell DRX wake-up indication. For example, a cell DTX wake-up may be indicated by a first DCI format, and a cell DRX wake-up may be indicated by a second DCI format. The first DCI format and the second DCI format may be a group common DCI format. The first DCI format and the second DCI format may be distinguished by different RNTIs. The first DCI format and the second DCI format may be distinguished by different DCI payload sizes. Additionally or alternatively to the above-described exemplary embodiment, the first DCI format and the second DCI format may be transmitted in different search space sets. In other words, the terminal may monitor different search space sets for a cell DTX wake-up operation and a cell DRX wake-up operation. When performing both operations, the terminal may receive configuration information of a plurality of RNTIs corresponding to the first DCI format and the second DCI format, a plurality of DCI payload sizes corresponding to the first DCI format and the second DCI format, and/or a plurality of search space sets corresponding to the first DCI format and the second DCI format.

Alternatively, an operation of indicating a cell DTX wake-up and an operation of indicating a cell DRX wake-up may be indicated by the same DCI format. For example, for one terminal, the wake-up DCI may include at least one of cell DTX operation indication information or cell DRX operation indication information, and the wake-up DCI may include a field or indicator for distinguishing between the cell DTX operation indication and the cell DRX operation indication. The field or indicator may be configured as 1 bit. The terminal may receive a first DCI to receive an indication of a cell DTX wake-up operation, and receive a second DCI having the same DCI format as the first DCI to receive an indication of a cell DRX wake-up operation. When the wake-up DCI includes a plurality of blocks or a plurality of fields corresponding to a plurality of terminals, a field or indicator for distinguishing the cell DTX operation indication and the cell DRX operation indication may be included in each block or each field. In this case, a value of the field or indicator may be determined independently for each terminal. For example, a first terminal and a second terminal receiving the same wake-up DCI may receive an indication of a cell DTX wake-up operation and an indication of a cell DRX wake-up operation, respectively, by using the same wake-up DCI.

Alternatively, both the cell DTX wake-up operation and the cell DRX wake-up operation may be indicated by one DCI. For example, cell DTX wake-up indication information and cell DRX wake-up indication information may be mapped to different fields (e.g., different bits) of the wake-up DCI. For another example, common indication information (e.g., information indicating a wake-up or information indicating to maintain an inactive time) may be applied to both the cell DTX operation and cell DRX operation. The wake-up DCI may include only cell DTX wake-up indication information. Alternatively, the wake-up DCI may include only cell DRX wake-up indication information. Alternatively, the wake-up DCI may include both the cell DTX wake-up indication information and cell DRX wake-up indication information. For example, the type (or combination, number) of information included in the wake-up DCI may be indicated to the terminal by a separate field included in the wake-up DCI. When the wake-up DCI includes a plurality of blocks or a plurality of fields corresponding to a plurality of terminals, the indication information (e.g., cell DTX wake-up indication information and/or cell DRX wake-up indication information) may be included in each block or each field. The indication information and the combination of the indication information may be independently determined for each terminal.

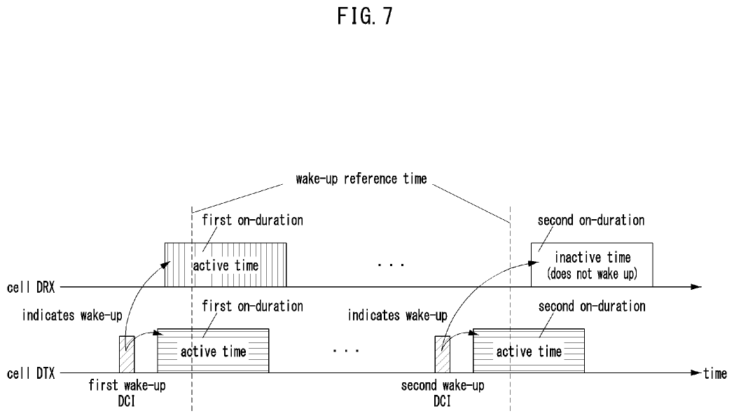

FIG. 7 is a conceptual diagram illustrating a first exemplary embodiment of a wake-up method of cell DTX and cell DRX.

Referring to FIG. 7, a terminal may perform a cell DTX operation and a cell DRX operation. A cell DTX cycle and a cell DRX cycle may be set to different values, and a cell DTX active time and a cell DRX active time may not match. The terminal may receive a wake-up DCI from a base station (e.g., one cell of the base station), and perform a cell DTX wake-up operation and a cell DRX wake-up operation based on the received wake-up DCI.

According to the above-described exemplary embodiment, the cell DTX wake-up operation and the cell DRX wake-up operation of the terminal may be performed when a predetermined condition is satisfied. To support the above-described operation, a wake-up reference time and/or time window may be defined. The terminal may determine a wake-up reference time and/or time window based on the received wake-up DCI, and may determine whether to perform the wake-up operation according to a relationship between the wake-up reference time and/or time window and a cell DTX/DRX on-duration. For example, when a start time of a cell DTX/DRX on-duration associated with the received wake-up DCI or a start time of a cell DTX/DRX on-duration that appears after a reception resource of the wake-up DCI is earlier (or not later) than the above-described reference time (e.g., wake-up reference time), the terminal may perform a wake-up operation for the cell DTX/DRX on-duration. For another example, when a cell DTX/DRX on-duration associated with the received wake-up DCI (or a cell DTX/DRX cycle corresponding to the cell DTX/DRX on-duration) or a cell DTX/DRX on-duration that appears after a reception resource of the wake-up DCI (or a cell DTX/DRX cycle corresponding to the cell DTX/DRX on-duration) is included in the above-described time window or overlaps with the above-described time window, the terminal may perform a wake-up operation for the cell DTX/DRX on-duration (or a cell DTX/DRX cycle corresponding to the cell DTX/DRX on-duration). In other words, the terminal may consider the cell DTX/DRX on-duration as an active time and perform a transmission or reception operation in the active time.

The reference time for wake-up indication may mean a C-th unit time resource (e.g., slot) that appears after a unit time resource (e.g., slot) in which the terminal receives the wake-up DCI, a start time of the C-th unit time resource (e.g., slot), or an end time of the C-th unit time resource (e.g., slot). C may be a natural number. The time window for wake-up indication may start at a D-th unit time resource (e.g., slot) that appears after the unit time resource (e.g., slot) in which the terminal receives the wake-up DCI, and the time window for wake-up indication may end at an E-th unit time resource (e.g., slot) that appears after the unit time resource (e.g., slot) in which the terminal receives the wake-up DCI. Each of D and E may be a natural number. D may be less than or equal to E.

Referring to FIG. 7, the terminal may receive a first wake-up DCI and a second wake-up DCI. The first wake-up DCI and the second wake-up DCI may indicate the terminal to perform cell DTX/DRX wake-up operations. A cell DTX on-duration and/or cell DRX on-duration to which the wake-up indication by the wake-up DCI is applied may be determined by a reference time determined based on a reception time of the wake-up DCI. For example, the indication by the wake-up DCI may be applied to cell DTX/DRX on-duration(s) that start before the reference time or start no later than the reference time among cell DTX on-durations and/or cell DRX on-durations associated with the wake-up DCI or cell DTX on-durations and/or cell DTX on-durations that appear after reception of the wake-up DCI. Alternatively, the indication by the wake-up DCI may be applied to cell DTX/DRX on-duration(s) that end before the reference time or end no later than the reference time among cell DTX on-durations and/or cell DRX on-durations associated with the wake-up DCI or cell DTX on-durations and/or cell DTX on-durations that appear after reception of the wake-up DCI.

Referring again to FIG. 7, a first cell DTX on-duration (e.g., first on-duration according to the cell DTX configuration) and a first cell DRX on-duration (e.g., first on-duration according to the cell DRX configuration) may be associated with the first wake-up DCI. The first cell DTX on-duration and the first cell DRX on-duration may start earlier than a reference time corresponding to the first wake-up DCI. According to the above-described method, the terminal may consider the indication of the first wake-up DCI as being applied to the first cell DTX on-duration and the first cell DRX on-duration among the cell DTX/DRX on-durations associated with the first wake-up DCI, consider the first cell DTX on-duration and the first cell DRX on-duration as active times, and perform operations corresponding to the active times in the first cell DTX on-duration and the first cell DRX on-duration. A second cell DTX on-duration (e.g., second on-duration according to the cell DTX configuration) and a second cell DRX on-duration (e.g., second on-duration according to the cell DRX configuration) may be associated with the second wake-up DCI. The second cell DTX on-duration may start earlier than a reference time corresponding to the second wake-up DCI, and the second cell DRX on-duration may start after the reference time. According to the above-described method, the terminal may consider the indication of the second wake-up DCI as being applied to the second cell DTX on-duration among the cell DTX/DRX on-durations associated with the second wake-up DCI, consider the second cell DTX on-duration as an active time, and perform an operation corresponding to the active time in the second cell DTX on-duration. The terminal may consider the indication of the second wake-up DCI as not being applied to the second cell DRX on-duration, and may maintain the inactive time in the second cell DRX on-duration.

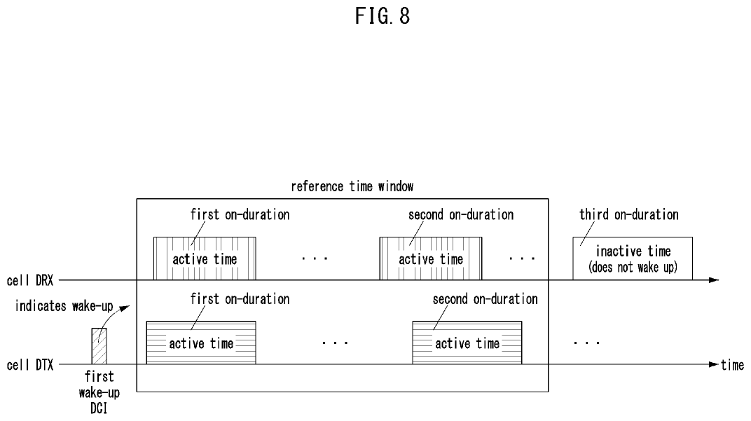

FIG. 8 is a conceptual diagram illustrating a second exemplary embodiment of a wake-up method of cell DTX and cell DRX.

Referring to FIG. 8, a terminal may perform a cell DTX operation and a cell DRX operation. A cell DTX cycle and a cell DRX cycle may be set to different values, and a cell DTX active time and a cell DRX active time may not match. The terminal may receive a wake-up DCI from a base station (e.g., one cell of the base station), and perform a cell DTX wake-up operation and a cell DRX wake-up operation based on the received wake-up DCI.

The terminal may receive a first wake-up DCI. The first wake-up DCI may include cell DTX wake-up indication information and/or cell DRX wake-up indication information. Specifically, the first wake-up DCI may include information indicating the terminal to consider the next cell DTX on-duration(s) and/or the next cell DRX on-duration(s) as active time(s). By the above-described method, the terminal may configure a reference time window based on the received first wake-up DCI. The reference time window may be referred to as a time window. On-duration(s) included within the reference time window or overlapping with the reference time window may be considered as a target to which the indication of the first wake-up DCI is applied. Referring to FIG. 8, a first cell DTX on-duration (e.g., first on-duration according to the cell DTX configuration) and a second cell DTX on-duration (e.g., second on-duration according to the cell DTX configuration) may be included within the reference time window, and the terminal may perform an operation corresponding to active times in the first cell DTX on-duration and the second cell DTX on-duration. A first cell DRX on-duration (e.g., first on-duration according to the cell DRX configuration) and a second cell DRX on-duration (e.g., second on-duration according to the cell DRX configuration) may be included within the reference time window, and the terminal may perform operations corresponding to the active times in the first cell DRX on-duration and the second cell DRX on-duration. A third cell DRX on-duration (e.g., third on-duration according to the cell DRX configuration) may not be included in the time window, and the terminal may maintain an inactive time in the third cell DRX on-duration.

As in the above-described exemplary embodiment, a common reference time or reference time window may be used to indicate cell DTX and cell DRX activation/inactivation. In order to increase operational flexibility of the base station, a method of configuring a reference time or reference time window for each of a cell DTX activation/inactivation operation and a cell DRX activation/inactivation operation may be considered. For example, C or (D, E) described above may be set independently for cell DTX and cell DRX. C or (D, E) for cell DTX may be set differently from C or (D, E) for cell DRX. Alternatively, C or (D, E) for cell DTX may be set equal to C or (D, E) for cell DRX. Information on C or (D, E) may be included in the wake-up DCI and/or higher layer signaling message, and the wake-up DCI and/or higher layer signaling message may be transmitted to the terminal. If the wake-up DCI includes both the cell DTX activation/inactivation indication information and the cell DRX activation/inactivation indication information, the reference time or reference time window for each of cell DTX and cell DRX may be determined based on a common reception time (e.g., slot, symbol, subframe, etc.) of the wake-up DCI.

The wake-up indication information may include information on the number of cell DTX/DRX cycle(s) and/or the number of cell DTX/DRX on-duration(s) to which the wake-up indication is applied. The information may be included in the wake-up DCI, and the wake-up DCI may be dynamically signaled to the terminal. The information may be transmitted to the terminal based on a higher layer signaling procedure (e.g., RRC signaling and/or MAC CE). This method may be performed in combination with the above-described method based on the reference time or reference time window. For example, the terminal may consider N1 cell DTX/DRX cycle(s) or cell DTX/DRX on-duration(s) and/or N2 cell DRX cycle(s) or cell DRX on-duration(s) among cell DTX/DRX cycle(s) or cell DTX/DRX on-duration(s) determined as target(s) to which the wake-up indication is applied based on the above-described reference time or reference time window as active time(s), and maintain inactive time(s) in the remaining cell DTX/DRX cycle(s) or cell DTX/DRX on-duration(s). N1 and N2 may each be natural numbers. N1 and N2 may have different values. N1 and N2 may be 1. If indication information or configuration information for N1 and/or N2 is not received, the terminal may apply default values predefined in the technical specifications for N1 and/or N2, and perform the cell DTX/DRX operations based on the default values.

According to the above-described method, the wake-up operation of the terminal may depend on a location of a resource in which the wake-up DCI is transmitted. In the present disclosure, a PDCCH monitoring occasion in which the terminal monitors the wake-up DCI may be referred to as ‘wake-up MO’. The wake-up MO may have the same cycle (e.g., the same cycle value) as the cell DTX cycle or the cell DRX cycle. Alternatively, the wake-up MO may have an integer multiple or integer factor relationship with the cell DTX cycle or cell DRX cycle. The wake-up MO may be configured based on a start time of an on-duration of cell DTX or a start time of an on-duration of cell DRX. For example, the wake-up MO may be arranged in slot(s) preceding a start slot of the cell DTX on-duration. Alternatively, the wake-up MO may be arranged in slot(s) preceding a start slot of the cell DRX on-duration. In other words, the wake-up MO may be arranged outside the cell DTX on-duration or outside the cell DRX on-duration. When the cell DRX wake-up DCI and the cell DTX wake-up DCI are transmitted in the same search space set(s) or when the cell DRX wake-up operation and the cell DTX wake-up operation are indicated by the same DCI, a resource to which the wake-up MO is mapped may be determined based on at least one of the cell DTX cycle or the cell DRX cycle. In the above-described exemplary embodiment, the wake-up MO may be arranged based on the cell DTX cycle (e.g., cell DTX on-duration location). A time period in which the wake-up MO can be arranged may be determined based on the cell DTX cycle (e.g., cell DTX on-duration location).

When the cell DRX wake-up DCI and the cell DTX wake-up DCI are transmitted in the same search space set(s) or when the cell DRX wake-up operation and the cell DTX wake-up operation are indicated by the same DCI, flexibility of cell DTX configuration and cell DRX configuration may be limited to a certain extent. For example, in the case described above, the cell DTX cycle and cell DRX cycle configured to the terminal may match. Alternatively, the cell DTX cycle and the cell DRX cycle may have an integer multiple relationship with each other. A cell DTX active time and a cell DRX active time may coincide or be partially aligned. For example, a distance between a start time of the cell DTX cycle (or active time, on-duration) and a start time of the cell DRX cycle (or active time, on-duration) may be set to a reference value or less. The start times, the distance between the start times, and the reference value may be defined in units of slots (or subslots, subframes, and ms).

The above-described DCI indicating whether to enter a cell DTX/DRX active time or inactive time may include information indicating a bandwidth part. The DCI indicating whether to enter a cell DTX/DRX active time or inactive time may include at least one of a cell DTX activation indication, cell DRX activation indication, cell DTX inactivation indication, or cell DRX inactivation indication. For example, the DCI indicating whether to enter a cell DTX inactive time may include information indicating a bandwidth part (e.g., downlink bandwidth part). The terminal may enter an inactive time by the indication of the DCI, activate the bandwidth part (e.g., downlink bandwidth part) indicated by the DCI in the inactive time, and receive downlink signals (e.g., SSB, PDDCH and PDSCH for paging and SIB transmission, CSI-RS, etc.) in the active bandwidth part within the inactive time. The cell DTX wake-up DCI may include information indicating a bandwidth part (e.g., downlink bandwidth part). The terminal may enter an active time by the indication of the DCI, activate the bandwidth part (e.g., downlink bandwidth part) indicated by the DCI in the active time, and receive downlink signals in the active bandwidth part within the active time. For another example, the DCI indicating whether to enter a cell DRX active time or a cell DRX inactive time may include information indicating a bandwidth part (e.g., uplink bandwidth part). The terminal may enter an active time or inactive time by the indication of the DCI, and transmit uplink signals (e.g., PRACH, SR, SRS, etc.) in the bandwidth part (e.g., uplink bandwidth part) indicated by the DCI within the active time or inactive time. Alternatively, the bandwidth part that the terminal activates in the cell DTX/DRX active or inactive time may be configured to the terminal by higher layer signaling (e.g., RRC message, MAC CE). The terminal may activate the configured bandwidth part at a time of entering the active time or inactive time, and perform transmission and reception operations in the activated bandwidth part. Configuration information of the bandwidth part may be configured for each of the cell DTX operation mode or cell DRX operation mode described above.

The above-described method may be equally applied not only to the wake-up DCI but also to the DCI that indicates whether to enter a cell DTX/DRX inactive mode. For example, cell DTX/DRX cycle(s), cell DTX/DRX inactive time(s), and/or cell DTX/DRX off-duration(s) to which the indication of whether to enter a cell DTX/DRX inactive mode is applied may be determined based on a reception time of the DCI and the reference time (or the reference time window). The number of cell DTX/DRX cycle(s), cell DTX/DRX inactive time(s), and/or cell DTX/DRX off-duration(s) to which the indication of whether to enter a cell DTX/DRX inactive mode is applied may be indicated or configured by the base station to the terminal based on the method described above.

An indication on whether to wake up in a cell DTX/DRX on-duration (hereinafter referred to as ‘first indication’) and an indication on whether to enter inactivity (e.g., inactive mode) in a cell DTX/DRX off-duration (hereinafter referred to as ‘second indication’) may be signaled based on the same DCI format. The terminal may monitor a DCI for the first indication and a DCI for the second indication in a common search space set and/or the same CORESET. According to the above description, it may be preferable for the DCI for the first indication to be monitored in a cell DTX inactive time (e.g., off-duration), and it may be preferable for the DCI for the second indication to be monitored in a cell DTX active time (e.g., on-duration). The common search space set (e.g., PDCCH MOs corresponding to the common search space set) may be arranged in both the cell DTX active time (e.g., on-duration) and cell DTX inactive time (e.g., off-duration). In other words, the terminal may perform the operation of monitoring the common search space set in both the cell DTX active time and the cell DTX inactive time.

In the above-described method, the terminal may interpret a payload of the DCI differently depending on a temporal location of an MO in which the DCI is received. For example, an interpretation of the DCI for a case where the MO in which the DCI is received falls within a cell DTX active time (e.g., on-duration) may be different from an interpretation of the DCI for a case where the MO in which the DCI is received falls within a cell DTX inactive time (e.g., off-duration). If the MO in which the DCI is received falls within a cell DTX active time (e.g., on-duration), the terminal may perform a first operation based on the interpretation of the payload in the DCI. If the MO in which the DCI is received falls within a cell DTX inactive time (e.g., off-duration), the terminal may perform a second operation based on the interpretation of the payload in the DCI. For example, the first operation may be an operation corresponding to the second indication, and the second operation may be an operation corresponding to the first indication. Alternatively, the DCI for the first indication and the DCI for the second indication may have CRCs scrambled by different RNTIs. The terminal may distinguish between the DCI for the first indication and the DCI for the second indication based on an RNTI applied to blind decoding, and perform an operation corresponding to the indication of the DCI.

Different search space sets may be configured in the terminal for the DCI for the first indication and the DCI for the second indication. For example, the DCI for the first indication may be monitored in a first search space set, and the first search space set may be arranged in a cell DTX inactive time (e.g., off-duration). The DCI for the second indication may be monitored in a second search space set, and the second search space set may be arranged in a cell DTX active time (e.g., on-duration). The first search space set and the second search space set may be associated with the same CORESET. For example, a frequency region to which the search space set is mapped, mapping between CCEs and REGs, PDCCH DM-RS mapping scheme, and/or whether interleaving is applied may be commonly applied to the first search space set and the second search space set. In addition, the first search space set and the second search space set may be configured with the same CCE aggregation level(s) and may include the same number of PDCCH candidates.

As described above, the base station may transmit a DCI including an activation or inactivation indication of a cell DTX operation and/or cell DRX operation to the terminal. The DCI may be transmitted by one cell of the base station. The one cell may be a primary cell. Alternatively, the one cell may not be a primary cell. The DCI transmitted by one cell (e.g., activation indication and/or inactivation indication included in the DCI) may be applied to the one cell and/or other cell(s). The activation of the cell DTX/DRX operation (e.g., activation indication) may mean enabling of the cell DTX/DRX operation, and the inactivation of the cell DTX/DRX operation (e.g., inactivation indication) may mean disabling of the cell DTX/DRX operation.

The terminal may receive the activation or inactivation indication for the cell DTX operation and/or cell DRX operation through the DCI. For example, a group common DCI may include information indicating to activate or inactivate the cell DTX operation configured in the terminal and/or information indicating to activate or inactivate the cell DRX operation configured in the terminal. The information indicating to activate or inactivate the cell DTX operation configured in the terminal and the information indicating to activate or inactivate the cell DRX operation configured in the terminal may each be expressed as 1 bit, and the information may be included in a DCI payload of the DCI. The indication for activation or inactivation of the cell DTX/DRX operation may be performed on a serving cell basis. The DCI may be referred to as ‘network energy saving (NES) DCI’.

When the DCI indicates activation of the cell DTX operation, the base station and/or terminal may enter a cell DTX active time and perform operations corresponding to the cell DTX active time. When the DCI indicates inactivation of the cell DTX operation, the base station and/or terminal may enter a cell DTX inactive time and perform operations corresponding to the cell DTX inactive time. When the DCI indicates activation of the cell DRX operation, the base station and/or terminal may enter a cell DRX activate time and perform operations corresponding to the cell DRX active time. When the DCI indicates inactivation of the cell DRX operation, the base station and/or terminal may enter a cell DRX inactive time and perform operations corresponding to the cell DRX inactive time.

When the terminal performs communication with a plurality of serving cells (e.g., first serving cell, second serving cell, etc.), cell DTX operations and/or cell DRX operations may be configured in the plurality of serving cells, and dynamic activation and inactivation operation of the cell DTX operations and/or cell DRX operations may be configured in the plurality of serving cells. In this case, the terminal may receive an indication for cell DTX/DRX activation and inactivation operations for the plurality of serving cells through one NES DCI. The one NES DCI may be transmitted by one serving cell (e.g., a primary cell or a non-primary cell) among the plurality of serving cells. Alternatively, the one NES DCI may be transmitted by a serving cell other than the plurality of serving cells. When a PCell (or primary secondary cell (PSCell)) is included in the plurality of serving cells, the one NES DCI may be transmitted by the PCell (or PSCell). A DCI indicating a cell DTX/DRX activation and/or inactivation operation for the PCell (or PSCell) may be transmitted only by the PCell (or PSCell). Alternatively, the NES DCI may be restricted to always be transmitted only by the PCell and/or PSCell.

In a certain case, the terminal may monitor the NES DCI in a plurality of serving cells. In other words, the terminal may receive configuration information of search space set(s) for NES DCI monitoring in the plurality of serving cells, and may perform NES DCI monitoring in the search space set(s). For example, when a dual connectivity operation is configured, the terminal may perform NES DCI monitoring in one serving cell for each cell group. In other words, the terminal may perform NES DCI monitoring in up to one serving cell for a master cell group (MCG), and may perform NES DCI monitoring in up to one serving cell for a secondary cell group (SCG). For another example, the terminal may receive additional configuration for a secondary DRX group from the base station. In other words, serving cells configured in the terminal may be classified into a plurality of DRX groups. In this case, the above-described operations may be performed for each DRX group. In other words, the plurality of serving cells may be serving cells belonging to the same DRX group. The NES DCI for the plurality of serving cells may be monitored in one of the serving cells belonging to the same DRX group. According to the above-described method, dynamic cell DTX/DRX activation and/or inactivation operations may be performed even when a plurality of DRX groups are configured in the terminal.

Indication information for the respective serving cells may be mapped to different bit strings (or information blocks). In the DCI payload, a start location of each bit string corresponding to each serving cell may be configured to the terminal. The starting location of each bit string may have a granularity of 1 bit. The terminal may obtain location(s) of one or more bit strings within the group common DCI based on the configuration information, and obtain cell DTX/DRX activation and/or inactivation indication information for each serving cell from each bit string. Each bit string may be configured as 1 bit or 2 bits. When a cell DTX or cell DRX activation and/or inactivation operation is configured in a certain serving cell, a bit string corresponding to the cell DTX or cell DRX activation/inactivation indication may be 1 bit, and when an activation and/or inactivation operation for both cell DTX and cell DRX is configured in a certain serving cell, a bit string corresponding to the activation/inactivation indication for cell DTX and cell DRX may be 2 bits.

Meanwhile, the terminal may receive a PDSCH from multiple TRPs or transmit a PUSCH to multiple TRPs. The terminal may receive a PDCCH from multiple TRPs or transmit a PUCCH to multiple TRPs. The multiple TRPs may belong to the same base station. The multiple TRPs may be TRPs belonging to the same serving cell, or may be TRPs belonging to different serving cells. In the latter case, the terminal may perform the above-described multiple TRP-based transmission operation with a first TRP belonging to a serving cell and a second TRP belonging to a neighboring cell. In this case, cell DTX/DRX operations and/or cell DTX/DRX activation/inactivation operations may be configured differently between the serving cell and the neighboring cell. Configuration information of the cell DTX/DRX operation of the neighboring cell may be signaled from the base station to the terminal. For example, a cell DTX/DRX pattern of the serving cell may be the same as or different from a cell DTX/DRX pattern of the neighboring cell. An activation/inactivation state of the cell DTX/DRX operation of the serving cell may be the same as or different from an activation/inactivation state of the cell DTX/DRX operation of the neighboring cell.

In the case described above, when a PDSCH is transmitted by a plurality of TCIs, for the same PDSCH, a PDSCH (e.g., PDSCH instance) received by a first TCI corresponding to a first cell (e.g., serving cell)) may belong to a cell DTX active time, and a PDSCH (e.g., PDSCH instance) received by a second TCI corresponding to a second cell (e.g., neighboring cell) may belong to a cell DTX inactive time. When the PDSCH is a PDSCH by dynamic scheduling, the terminal may receive both the PDSCH (e.g., PDSCH instance) received by the first TCI and the PDSCH (e.g., PDSCH instance) received by the second TCI. In other words, the above-described reception operation may be performed regardless of the cell DTX operation. On the other hand, when the PDSCH is an SPS PDSCH, the terminal may skip both the reception operation of the PDSCH (e.g., PDSCH instance) by the first TCI and the PDSCH (e.g., PDSCH instance) by the second TCI. Alternatively, the terminal may receive only the PDSCH (e.g., PDSCH instance) by the first TCI belonging to the active time. The terminal may skip the reception operation of the PDSCH (e.g., PDSCH instance) by the second TCI in the inactive time. The PDSCHs may be scheduled by one DCI, and the DCI may indicate a plurality of TCIs for receiving the PDSCHs.

A search space set for NES DCI monitoring may appear periodically and repeatedly according to a predetermined periodicity value. The search space set may be referred to as ‘NES search space set’. The NES search space set may be arranged in both a cell DTX active time and a cell DTX inactive time. The terminal may monitor the NES search space set regardless of the cell DTX operation and receive the NES DCI in the NES search space set. In other words, the terminal may monitor and receive the NES DCI in the cell DTX active time, and monitor and receive the NES DCI in the cell DTX inactive time.

Meanwhile, an NES search space set monitoring periodicity in the cell DTX inactive time (or terminal DRX inactive time) may be different from an NES search space set monitoring periodicity in the cell DTX active time (or terminal DRX active time). In an exemplary embodiment below, a cell DTX inactive time and a cell DTX active time may refer to a terminal DRX inactive time and a terminal DRX active time, respectively. For example, for the purpose of reducing cell DTX/DRX inactivation delay time, a periodicity of the NES search space set (e.g., PDCCH monitoring occasions corresponding to the NES search space set) monitored by the terminal in the cell DTX active time may be relatively short. In other words, the number, frequency, and/or density of the NES search space sets (e.g., PDCCH monitoring occasions corresponding to the NES search space sets) that the terminal monitors in the cell DTX active time may be relatively small. The periodicity may be referred to as a first periodicity or a first periodicity value (or first frequency, first density, etc.). On the other hand, for the purpose of saving power of the network and the terminal, the terminal may monitor the NES search spaces (e.g., PDCCH monitoring occasions corresponding to the NES search space sets) based on a relatively longer periodicity in the cell DRX active time. In other words, the number, frequency, and/or density of the NES search space sets (e.g., PDCCH monitoring occasions corresponding to the NES search space sets) that the terminal monitors in the cell DTX inactive time may be relatively large. The periodicity may be referred to as a second periodicity or a second periodicity value (or second frequency, second density, etc.).

As a method to support the above-described monitoring operation, the base station may configure two (e.g., up to two) NES search space sets in the terminal. The terminal may monitor the NES DCI in the configured NES search space set(s). For example, a first NES search space set may be configured with the first periodicity, first in-slot monitoring pattern, etc. for monitoring operation in the cell DTX active time, and a second NES search space set may be configured with the second periodicity, second in-slot monitoring pattern, etc. for monitoring operation in the cell DTX inactive time.

According to an exemplary embodiment, the terminal may monitor the same DCI format in the first NES search space set and the second NES search space set. For example, the DCI format may be a format corresponding to the NES DCI. The DCI format may be a group common DCI format (e.g., DCI 2_X, where X is a natural number). The terminal may perform PDCCH monitoring based on the same RNTI in the first NES search space set and the second NES search space set. The RNTI may be an RNTI (e.g., NES-RNTI) that is distinct from C-RNTI. Both the first NES search space set and the second NES search space set may be CSS sets (e.g., Type 3 CSS sets). The first NES search space set and the second NES search space set may be configured independently. In other words, parameters constituting configuration information of the first NES search space set may be determined independently of parameters constituting configuration information of the second NES search space set. Alternatively, the configuration information of the first NES search space set may be associated with the configuration information of the second NES search space set. For example, configuration parameters (e.g., CCE aggregation level, number of PDCCH candidates, search space set type, etc.) excluding periodicity, offset, in-slot monitoring pattern, etc. may be configured to be the same values between the first NES search space set and the second NES search space set. The terminal may monitor the first NES search space set and the second NES search space set based on one CORESET.

According to another exemplary embodiment, the terminal may monitor a first DCI format and a second DCI format in the first NES search space set and the second NES search space set for dynamic cell DTX/DRX activation and inactivation operations, respectively. For example, the first DCI format may be a scheduling DCI format (e.g., DCI format 0_1/0_2, DCI format 1_1/1_2, etc.), and the second DCI format may be a group common DCI format (e.g., DCI 2_X, X may be a natural number). The first NES search space set and the second NES search space set may be configured with different types. For example, the first NES search space set may be a USS set, and the second NES search space set may be a CSS set. The first NES search space set and the second NES search space set may be configured independently.

The first NES search space set and the second NES search space set may be limited to be monitored only in specific periods. For example, the first NES search space set may be monitored only in cell DTX active times. The second NES search space set may be monitored only in cell DTX inactive times. When the first NES search space set is a USS set, the terminal may monitor the first NES search space set even in a cell DTX inactive time when a predetermined condition is satisfied (e.g., while an HARQ retransmission timer is running).

The above-described operation may be performed also when one NES search space set is configured. The terminal may determine a plurality (e.g., two) PDCCH monitoring occasion periodicities (or periodicity values, frequencies, densities, sets, etc.) based on configuration information of the one NES search space set. The configuration information of the one NES search space set may include configuration information for the plurality (e.g., two) PDCCH monitoring occasion periodicities (or periodicity values, frequencies, densities, sets, etc.). For example, the terminal may monitor the NES DCI based on a first PDCCH monitoring occasion periodicity (or periodicity value, frequency, density, set) in the cell DTX active times, and monitor the NES DCI based on a second PDCCH monitoring occasion periodicity (or periodicity value, frequency, density, set) in the cell DTX inactive times.

The plurality (e.g., two) PDCCH monitoring occasion periodicities (or periodicity values, frequencies, densities, sets, etc.) may be determined based on configuration information other than the configuration information of the NES search space set. For example, the terminal may receive information from the base station indicating to skip a monitoring operation for some monitoring occasions in the NES search space set. For example, the terminal may receive configuration of a time window from the base station and monitor only PDCCH monitoring occasions belonging to the time window. Alternatively, the terminal may monitor only PDCCH monitoring occasions that do not belong to the time window. By appropriately arranging the time window, the base station may indicate the terminal to perform different PDCCH monitoring operations in cell DTX active times and cell DTX inactive times.

A time at which the terminal applies the operation indicated by the NES DCI may be defined. The application time of the NES DCI may be defined as a predetermined time after the terminal receives the NES DCI (e.g., a slot in which the NES DCI is received, the last symbol of the NES DCI). The application time may be a first-located symbol of a first slot. The first slot may be a slot after D1 slots from the slot in which the NES DCI is received. Alternatively, the first slot may be a first-located slot that is not earlier than a symbol after D2 symbols from the last symbol of the NES DCI. Each of D1 and D2 may be a natural number. The application delay time (e.g., D1, D2, a time determined based on D1, a time determined based on D2) may be determined based on a subcarrier spacing of a serving cell that is a target to which the activation/inactivation indication (e.g., cell DTX and/or cell DRX activation/inactivation indication) is applied. Alternatively, the application delay time may be determined based on a subcarrier spacing of a serving cell from which the NES DCI is received. In other words, the first slot may be a slot of the serving cell from which the NES DCI is received. If the subcarrier spacing of the cell to which the activation/inactivation indication is applied is different from the subcarrier spacing of the first slot, the terminal may apply the indicated activate/inactive state and operations corresponding to the activation/inactivation from a first-located slot not earlier than a start time of the first slot among the slots of the cell to which the activation/inactivation indication is applied. The above-described method may be referred to as (Method 100).

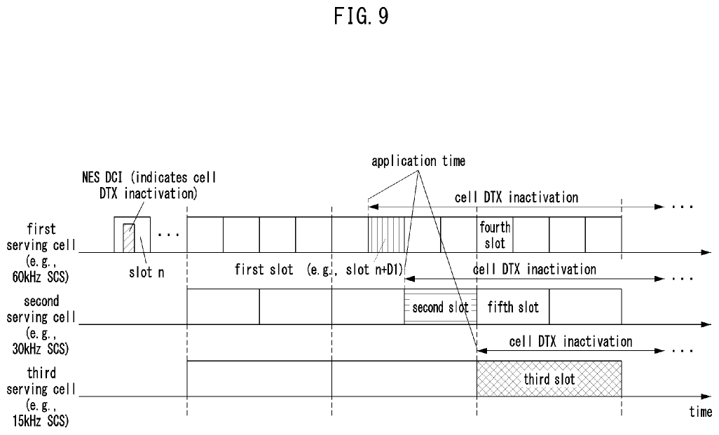

FIG. 9 is a conceptual diagram illustrating a first exemplary embodiment of a cell DTX inactivation indication method by (Method 100).

Referring to FIG. 9, the terminal may communicate with the base station using three serving cells. Different subcarrier spacings may be applied to the serving cells. For example, subcarrier spacings of first, second, and third serving cells may be set to 60 kHz, 30 kHz, and 15 kHz, respectively. The base station may indicate the terminal to perform cell DTX operations in the three serving cells. The first serving cell of the base station may transmit an NES DCI. By the above-described method, the terminal may monitor the NES DCI in the first serving cell, and the NES DCI may indicate cell DTX/DRX activation and/or inactivation operations for the three serving cells to the terminal.

The terminal may receive the NES DCI in a slot n of the first serving cell, and the NES DCI may indicate to perform a cell DTX inactivation operation in the first serving cell, second serving cell, and third serving cell. According to (Method 100), the indication (e.g., cell DTX inactivation indication) may be applied from a slot n+D1. In other words, in case of the first serving cell, the terminal may switch to a cell DTX inactive state or maintain the cell DTX inactive state from a first slot, and perform operations corresponding to the cell DTX inactive state. In case of the second serving cell, the terminal may switch to a cell DTX inactive state or maintain the cell DTX inactive state from a slot (e.g., second slot) not earlier than the first slot, and perform operations corresponding to the cell DTX inactive state. In case of the third serving cell, the terminal may switch to a cell DTX inactive state or maintain the cell DTX inactive state from a slot (e.g., third slot) not earlier than the first slot, and perform operations corresponding to the cell DTX inactive state. As a result, times at which the indication (e.g., cell DTX inactivation indication) is applied may differ between the serving cells. In other words, a delay time from when the terminal receives the DCI to when the indication by the DCI (e.g., cell DTX inactivation indication) is applied may vary for each serving cell or for each subcarrier spacing. As a result, dormant or non-dormant states of the serving cells may need to be managed for each serving cell, which may increase the operational complexity and power consumption of the base station.

As a method to solve the above-described problem, the terminal may apply all activation/inactivation indications by one NES DCI at one common time. In the above-described exemplary embodiment, the terminal may determine a common time to apply the cell DTX inactivation indications for the first serving cell, the second serving cell, and the third serving cell, and switch the serving cell to the cell DTX inactive state or maintain the cell DTX inactive state from the determined time (e.g., a slot corresponding to the determined time). For example, the common time may be a start time of the third slot of the third serving cell. The terminal may switch the first serving cell, the second serving cell, and the third serving cell to the cell DTX inactive state or maintain them in the cell DTX inactive state from a forth slot of the first serving cell, a fifth slot of the second serving cell, and the third slot of the third serving cell, which are first-appearing slots not earlier than the start time, respectively.

As another method to solve the above-described problem, a predetermined condition may be established between a subcarrier spacing of a serving cell in which the terminal monitors the NES DCI (hereinafter referred to as ‘first subcarrier spacing’) and a subcarrier spacing of a serving cell to which the activation/inactivation indication of the NES DCI is applied (hereinafter referred to as ‘second subcarrier spacing’). For example, the first subcarrier spacing may have a value that is not greater than (e.g., smaller than or equal to) the second subcarrier spacing. According to the above-described method, the operation shown in FIG. 9 may be excluded. According to the above-described method, in order to control cell DTX/DRX operations for the first serving, second serving, and third serving cells with one NES DCI, the terminal may perform NES DCI monitoring in the third serving cell with the smallest subcarrier spacing.

According to the indication of the NES DCI, the terminal may switch its operation from the active operation (e.g., operation for active times) to the inactive operation (e.g., operation for inactive times). The switching (e.g., switching operation) may be referred to as ‘first switching (e.g., first switching operation)’. Alternatively, according to the indication of the NES DCI, the terminal may switch its operation from the inactive operation to the active operation. The switching (e.g., switching operation) may be referred to as ‘second switching (e.g., second switching operation)’. An application delay time when a result of the indication of the NES DCI is the first switching may be defined differently from an application delay time may be defined differently from the value of the application delay time when a result of the indication of the NES DCI is the second switching. In case of the first switching, since the terminal can simply drop transmission that is being prepared in the active time, the first switching operation may be performed quickly. On the other hand, a time required for the second switching operation may vary depending on an implemented operation of the terminal during the inactive time, and a relatively long switching time may need to be guaranteed to ensure a transmission and reception operation immediately after the second switching and a preprocessing time for the transmission and reception operation. The application delay time for the indication of the first switching operation may have a smaller value (or a value not greater) than the application delay time for the indication of the second switching operation. The size relationship may be established for all subcarrier spacings. Alternatively, the size relationship may be applied limitedly to some subcarrier spacings. The size relationship may be applied to both cell DTX operation switching and cell DRX operation switching.

Meanwhile, a cell DTX operation and a terminal-specific DRX operation (e.g., terminal DRX operation, UE DRX operation, UE-specific DRX operation, DRX operation) may be configured simultaneously in the terminal. The terminal may perform both the cell DTX operation and terminal-specific DRX operation. For example, the terminal may be a terminal in the RRC connected state, and the terminal-specific DRX may mean C-DRX. The terminal may perform a PDCCH monitoring operation in terminal-specific DRX active times, and may skip the PDCCH monitoring operation in terminal-specific DRX inactive times (e.g., periods outside the active times). The cell DTX operation and terminal-specific DRX operation may be operations that increase the power efficiency of the base station (or network) and terminal, respectively. The cell DTX operation and the terminal-specific DRX operation may be configured for different purposes. The cell DTX configuration and the terminal-specific DRX configuration may be independent of each other. For example, a cycle and/or on-duration of cell DTX may not match a cycle and/or on-duration of terminal-specific DRX. Operations of the terminal in the cell DTX active times and cell DTX inactive times may be different from operations of the terminal in the terminal-specific DRX active times and terminal-specific DRX inactive times.

A cell DRX operation and a terminal-specific DRX operation may be configured simultaneously in the terminal. The terminal may perform both the cell DRX operation and terminal-specific DRX operation. For example, the terminal may be a terminal in the RRC connected state, and the terminal-specific DRX may mean C-DRX. The terminal may perform a transmission operation of specific uplink signal(s), and skip the transmission operation of the specific uplink signal(s) in terminal-specific DRX inactive times (e.g., periods outside the active times). The cell DRX operation and terminal-specific DRX operation may be operations that increase the power efficiency of the base station (or network) and terminal, respectively. The cell DRX operation and the terminal-specific DRX operation may be configured for different purposes. The cell DRX configuration and the terminal-specific DRX configuration may be independent of each other. For example, a cycle and/or on-duration of cell DRX may not match a cycle and/or on-duration of terminal-specific DRX. Operations of the terminal in the cell DRX active times and cell DRX inactive times may be different from operations of the terminal in the terminal-specific DRX active times and terminal-specific DRX inactive times.

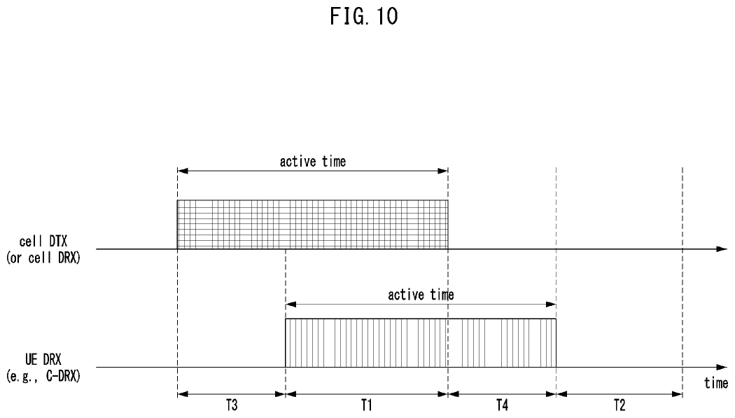

FIG. 10 is a conceptual diagram illustrating a first exemplary embodiment of a method for arranging cell DTX/DRX active times and terminal-specific DRX active times.

Referring to FIG. 10, a terminal may simultaneously perform a cell DTX/DRX operation and a terminal-specific DRX (e.g., C-DRX) operation. The terminal may perform a first operation and a second operation in cell DTX/DRX active times and inactive times, respectively, and may perform a third operation and a fourth operation in terminal-specific active times and inactive times, respectively. For cell DTX, the first operation may mean a general downlink reception operation, and the second operation may mean a monitoring operation or reception operation for a first signal set. For cell DRX, the first operation may mean a general uplink transmission operation, and the second operation may mean a transmission operation for a second signal set. The third operation may mean a PDCCH monitoring operation and a general downlink reception operation. The fourth operation may mean an operation not performing PDCCH monitoring and a reception operation for a third signal set. The fourth operation may mean a transmission operation for a fourth signal set. The first to fourth signal sets may be sets of signal(s) and/or channel(s) that the terminal receives or transmits during the cell DTX/DRX inactive time for low-power operation, respectively.

In a certain time period, a cell DTX active time (or cell DRX active time) and a terminal-specific DRX active time may partially overlap. Referring to FIG. 10, in a period T1, a cell DTX active time (or cell DRX active time) and a terminal-specific DRX active time may overlap. The terminal may perform the first and third operations in the period T1. In other words, the terminal may perform a PDCCH monitoring operation and a general downlink reception operation in the period T1. The terminal may perform a general uplink transmission operation in the period T1.

In a period T2, a cell DTX inactive time (or cell DRX inactive time) and a terminal-specific DRX inactive time may overlap. Unlike the period T1, operations of the terminal in the period T2 may be defined in various forms. For example, the terminal may selectively perform either the second operation in the cell DTX inactive time (or cell DRX inactive time) or the fourth operation in the terminal-specific DRX inactive time. The terminal may perform the second operation (e.g., a monitoring operation or a reception operation for the first signal set). In other words, the terminal may skip an operation of receiving signals belonging to a difference set excluding the first signal set from the third signal set. For example, the terminal may skip an operation of receiving periodic or semi-persistent CSI-RS in the period T2. Alternatively, the terminal may skip an operation of receiving an SPS PDSCH in the period T2. The periodic CSI-RS, semi-persistent CSI-RS, and/or SPS PDSCH may be included in the third signal set, and the periodic CSI-RS, semi-persistent CSI-RS, and/or SPS PDSCH may not be included in the first signal set.

The terminal may perform the second operation (e.g., a transmission operation for the second signal set). In other words, the terminal may skip an operation of transmitting signals belonging to a difference set excluding the second signal set from the fourth signal set. Alternatively, the terminal may perform the fourth operation (e.g., a monitoring operation or a reception operation for the third signal set) and may perform a transmission operation for the fourth signal set. In other words, the terminal may skip an operation of receiving signals belonging to a difference set excluding the third signal set from the first signal set, or may skip an operation of receiving signals belonging to a difference set excluding the fourth signal set from the second signal set. For example, the terminal may skip an operation of transmitting periodic or semi-persistent SRS in the period T2. Alternatively, the terminal may skip an operation of transmitting a CG PUSCH in the period T2. The periodic SRS, semi-persistent SRS, and/or CG PUSCH may be included in the fourth signal set, and the periodic SRS, semi-persistent SRS, and/or CG PUSCH may not be included in the second signal set.

Alternatively, the terminal may perform both the second operation and the fourth operation. In other words, the terminal may perform monitoring or reception operations for the first signal set and the third signal set. The terminal may perform a transmission operation for the second signal set and the fourth signal set. For example, the terminal may perform a periodic CSI-RS reception operation, a semi-persistent CSI-RS reception operation, an aperiodic CSI-RS reception operation, and/or an SPS PDSCH reception operation in the period T2. The terminal may perform a periodic SRS transmission operation, a semi-persistent SRS transmission operation, an aperiodic SRS transmission operation, and/or a CG PUSCH transmission operation in the period T2. Additionally or alternatively to the above-described exemplary embodiment, operations of the terminal in the period T2 may be determined based on an inclusion relationship between the first signal set and the third signal set, or may be determined based on an inclusion relationship between the second signal set and the fourth signal set.

In a period T3, a cell DTX active time (or cell DRX active time) and a terminal-specific DRX inactive time may overlap. In the period T3, a PDCCH monitoring operation of the terminal may be defined. For example, the terminal may not perform a PDCCH monitoring operation according to the terminal-specific DRX operation. Alternatively, the terminal may perform a PDCCH monitoring operation according to the cell DTX operation. In other words, in the period T3, a PDCCH monitoring operation by cell DTX may take priority over a PDCCH monitoring operation by terminal-specific DRX. The PDCCH monitoring operation performed in the period T3 may coincide with the PDCCH monitoring operation performed in the period T1. For example, the terminal may perform a blind decoding operation for the same CORESET(s) and the same search space set(s) in the period T1 and the period T3. The terminal may monitor the same DCI format(s) and/or the same RNTI(s) in the period T1 and the period T3. The operation of indicating to skip PDCCH monitoring and/or the operation of indicating SSSG switching may be performed without distinguishing between the period T1 and the period T3. For example, until receiving a separate SSSG switching indication, the terminal may monitor the same SSSG in slots belonging to the period T1 and slots belonging to the period T3.

Alternatively, the terminal may perform a PDCCH monitoring operation on a difference set between a PDCCH monitoring resource set monitored in cell DTX active times and a PDCCH monitoring resource set monitored in terminal-specific DRX active times. For example, CORESET(s), search space set(s), DCI format(s), and/or RNTI(s) that the terminal monitors in cell DTX active times may be different from CORESET(s), search space set(s), DCI format(s), and/or RNTI(s) that the terminal monitors in terminal-specific DRX active times. An inclusion relationship may not be established between the former and the latter. In this case, switching from the period T1 to the period T3 or switching from the period T3 to the period T1 may affect the operation of indicating to skip PDCCH monitoring or the operation of indicating SSSG switching. For example, the terminal may monitor different SSSGs in the period T1 and the period T3.

In the period T3, a downlink reception operation and/or uplink transmission operation of the terminal may be defined. For example, the terminal may perform the first operation (e.g., general downlink reception operation) according to the cell DTX operation. For example, the terminal may perform a reception operation of downlink signal(s) (e.g., all downlink signals) defined in technical specifications or a reception operation of all downlink signals configured by the base station in the period T3. Alternatively, the terminal may perform the fourth operation (e.g., limited reception operation for the third signal set) according to the terminal-specific DRX operation. For example, the terminal may not receive downlink signals (e.g., CSI-RS, periodic or semi-persistent CSI-RS) that are not included in the third signal set in the period T3. Similarly, the terminal may perform the first operation (e.g., general uplink transmission operation) following the cell DRX operation. For example, the terminal may perform a transmission operation of uplink signals (e.g., all uplink signals) defined in technical specifications or a transmission operation of all uplink signals configured by the base station in the period T3. Alternatively, the terminal may perform the fourth operation (e.g., limited transmission operation for the fourth signal set) according to the terminal-specific DRX operation.

For example, an SRS resource configured in the terminal may be arranged in the period T3. The terminal may transmit an SRS in the SRS resource based on the cell DRX operation, and the terminal may transmit a PUSCH based on the SRS resource. In other words, the SRS resource may be indicated as a reference resource for PUSCH transmission by an SRS resource indicator (SRI). For another example, the terminal may not transmit an SRS in the SRS resource based on the terminal-specific DRX (e.g., C-DRX) operation. The SRS resource may be excluded from candidate reference resources for PUSCH transmission. The SRS resource may be an SRS resource configured periodically or semi-persistently. The SRS resource may not belong to the fourth signal set.

In a period T4, a cell DTX inactive time (or cell DRX inactive time) and a terminal-specific DRX active time may overlap. In the period T4, a PDCCH monitoring operation of the terminal may be defined. For example, a PDCCH monitoring operation by terminal-specific DRX may take priority over a PDCCH monitoring operation by cell DTX. The terminal may perform a PDCCH monitoring operation according to the terminal-specific DRX operation even though the cell DTX is inactivated in the period T4. Alternatively, the terminal may not perform a PDCCH monitoring operation according to the cell DTX operation even though the terminal-specific DRX is activated. Alternatively, the terminal may perform a PDCCH monitoring operation for a limited set of PDCCH monitoring resources according to the cell DTX operation. The PDCCH monitoring operation may coincide with an operation performed by the terminal in the cell DTX inactive time. For example, the PDCCH monitoring operation of the terminal in the period T4 may coincide with the PDCCH monitoring operation in the period T2. For example, the terminal,au monitor a specific type of search space set in the period T4. In the NR communication system, the specific type of search space set may include a Type 0, Type 0A, Type 1, and/or Type 2 CSS set. The terminal may monitor and receive a PDCCH for paging, PDCCH for scheduling a PDSCH including system information, and/or PDCCH for scheduling a PDSCH including Msg2, Msg4, etc. in the search space set. The search space set may include a Type 3 CSS set. Alternatively, the terminal may perform a PDCCH monitoring operation on a difference set between a PDCCH monitoring resource set monitored in cell DTX active times and a PDCCH monitoring resource set monitored in terminal-specific DRX active times.

In the period T4, a downlink reception operation and an uplink transmission operation of the terminal may be defined. For example, the terminal may perform the second operation (e.g., reception operation for the first signal set) according to the cell DTX operation. For example, the terminal may receive a dynamically scheduled downlink signal, aperiodic CSI-RS, TRS (or CSI-RS for tracking), and/or PRS in the period T4, and may skip a reception operation of an SPS PDSCH, periodic CSI-RS, and/or semi-persistent CSI-RS. The downlink reception operation in the period T4 section may coincide with the downlink reception operation in the period T2. Alternatively, the terminal may perform the third operation (e.g., general downlink reception operation) according to the terminal-specific DRX operation. Similarly, the terminal may perform the second operation (e.g., transmission operation for the second signal set) according to the cell DRX operation. For example, the terminal may transmit a dynamically scheduled uplink signal, aperiodic SRS, and/or SRS configured for positioning in the period T4, and may skip a transmission operation of a CG PUSCH, periodic SRS, and/or semi-persistent SRS. The uplink transmission operation in the period T4 may coincide with the uplink transmission operation in the period T2. Alternatively, the terminal may perform the third operation (e.g., general uplink transmission operation) according to the terminal-specific DRX operation.

For example, a CSI-RS resource configured for the terminal may be arranged in the period T4. The terminal may receive a CSI-RS in the CSI-RS resource based on the terminal-specific DRX (e.g., C-DRX) operation, and may measure and report CSI based on CSI-RS resource(s) including the CSI-RS resource. Alternatively, when configured to receive the CSI-RS resource in a cell DTX inactive time, the terminal may receive the CSI-RS in the CSI-RS resource in the period T4 based on the cell DTX operation, and measure and report CSI based on CSI-RS resource(s) including the CSI-RS resource. When configured not to receive the CSI-RS resource in a cell DTX inactive time, the terminal may not receive a CSI-RS in the CSI-RS resource within the period T4 based on the cell DTX operation, and may measure and report CSI based CSI-RS resource(s) excluding the CSI-RS resource. In other words, whether or not to receive the CSI-RS resource in the period T4 may be determined based on the cell DTX operation mode. The measurement may include CSI calculation, RRM/RLM measurement, beam quality measurement, and/or SINR measurement.

In the period T4, an operation of the terminal may be determined by whether the active time is extended. For example, if a terminal-specific DRX active time is extended by a timer in the period T4, the terminal may perform a fifth operation in the period T4. If a terminal-specific DRX active time in the period T4 falls within the originally-configured on-duration, the terminal may perform a sixth operation in the period T4. If there is a signal to be additionally transmitted to the terminal and/or if the terminal wishes to transmit an additional signal, the active time may be extended. Considering the above-described operations, the fifth operation may be an operation that performs PDCCH monitoring, and the sixth operation may be an operation that does not perform PDCCH monitoring. Alternatively, the sixth operation may be an operation that performs PDCCH monitoring in a limited manner. According to the above-described method, the terminal may receive a scheduling DCI by performing a PDCCH monitoring operation when additional transmission is expected. If additional transmission is not expected, the terminal may reduce power consumption by skipping the PDCCH monitoring operation according to the cell DTX operation. Similarly, a transmission operation of the terminal in the period T3 may be determined by whether the cell DRX active time is extended in the period T3.

Meanwhile, the timers (e.g., DRX inactivity timer, on-duration timer, etc.) may operate in cell DTX/DRX and terminal-specific DRX, respectively. The active time of cell DTX (or cell DRX) may be determined by a first timer, and the active time of terminal-specific DRX may be determined by a second timer. Alternatively, the timers may operate independently for cell DTX and cell DRX. For example, the terminal may consider cell DTX (or cell DRX) as in the active time in a period in which the first timer operates (e.g., period until an expiration of the first timer), and may consider terminal-specific DRX as in the active time in a period (e.g., period until an expiration of the second timer).

In this case, the first timer or cell DTX active time may be determined by the second timer. For example, the first timer may be aligned with the second timer. While the second timer is operating, the terminal may also operate the first timer. When the second timer starts (or restarts), the terminal may also start (or restart) the first timer. As a result, a period in which the second timer operates may be considered a cell DTX (or cell DRX) active time. Alternatively, the terminal may consider a period in which the second timer operates as a cell DTX (or cell DRX) active time regardless of the first timer.

Similarly, the second timer or terminal-specific DRX active time may be determined by the first timer. For example, the second timer may be aligned with the first timer. While the first timer is operating, the terminal may also operate the second timer. When the first timer starts (or restarts), the terminal may also start (or restart) the second timer. As a result, a period in which the first timer operates may be regarded as a terminal-specific DRX active time. Alternatively, the terminal may consider a period in which the first timer operates as a terminal-specific DRX active time regardless of the second timer.

Both the cell DTX operation and terminal-specific DRX operation may be performed based on a wake-up operation. In this case, as a method of indicating the terminal to perform a wake-up operation, a DCI indicating a wake-up operation for cell DTX and a DCI indicating a wake-up operation for terminal-specific DRX may distinguished by the terminal, and the DCIs may be individually transmitted to the terminal. For example, a cell DTX wake-up DCI and a terminal-specific DRX wake-up DCI may correspond to different DCI formats, different RNTIs, different DCI payload sizes, and/or different search space sets.

For example, the DCI (e.g., DCI for the first indication) indicating wake-up of cell DTX may follow a DCI format A, and the DCI indicating wake-up of terminal-specific DRX may follow a DCI format B. The DCI Format A and DCI Format B may be group common DCIs and may be monitored in a Type 3 CSS set. The DCI format A and DCI format B may have CRCs scrambled by different RNTIs. The DCI format A and DCI format B may be configured to have different payload sizes. The terminal may receive configuration of a first search space set for DCI format A monitoring and/or a second search space set for DCI format B monitoring. In this case, the first search space set and the second search space set may be configured independently. For example, MOs of the first search space set (e.g., wake-up MOs for cell DTX) may be configured based on a cell DTX cycle, and MOs of the second search space set (e.g., wake-up MOs for terminal-specific DRX) may be configured based on a terminal-specific DRX cycle separately from the above configuration. The first search space set and the second search space set may be associated with the same CORESET.

Alternatively, the terminal may monitor both the DCI format A and DCI format B in a common search space set. In this case, as a method to reduce PDCCH blind decoding complexity, if the payload sizes of the DCI format A and DCI format B are different, the base station may add bit(s) or a bitstring set to predefined values (e.g., 0) to a DCI having a smaller payload size until the payload sizes of the DCI format A and DCI format B are the same. The DCI format A and DCI format B may still be distinguished by different RNTIs, and the terminal may monitor both the DCI format A and DCI format B through one blind decoding operation for each PDCCH candidate.

The above-described method may also be applied to a DCI (e.g., DCI for the second indication) indicating whether to enter inactivity in a cell DTX/DRX off-duration. For example, a DCI for the second indication may follow the DCI format A, and a DCI indicating wake-up of terminal-specific DRX may follow the DCI format B. The above-described methods may be equally applied to transmission, monitoring, and/or reception operations of the DCI format A and DCI format B.

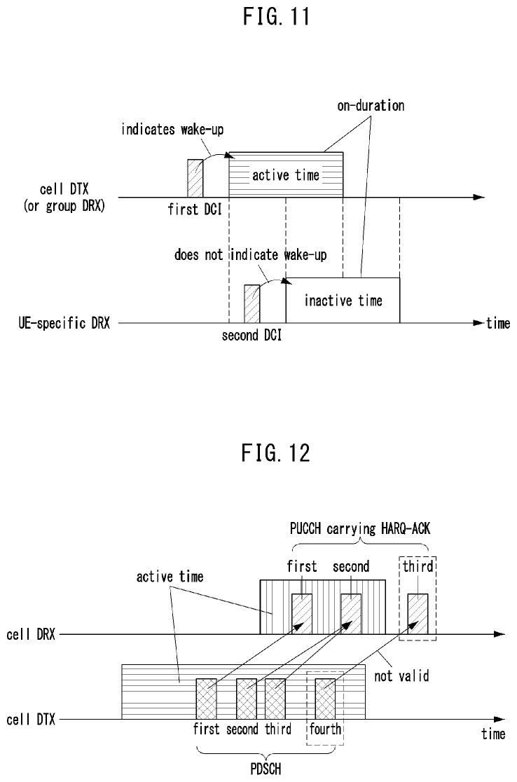

FIG. 11 is a conceptual diagram illustrating a first exemplary embodiment of a wake-up method of cell DTX and terminal-specific DRX.

Referring to FIG. 11, a terminal may simultaneously perform a cell DTX operation and a terminal-specific DRX operation. The cell DTX operation and terminal-specific DRX operation may be performed based on wake-up operations. The terminal may receive a first DCI, which is a cell DTX wake-up DCI, and the first DCI may indicate to perform a wake-up operation. Accordingly, the terminal may consider the next cell DTX on-duration as an active time, and perform a downlink signal reception operation corresponding to the active time. The terminal may perform a PDCCH monitoring operation in the next cell DTX on-duration. The terminal may receive a second DCI, which is a terminal-specific wake-up DCI, and the second DCI may indicate not to perform a wake-up operation. Accordingly, the terminal may regard the next terminal-specific DRX on-duration as an inactive time, and may not perform a PDCCH monitoring operation.

Referring to FIG. 11, a cell DTX on-duration and a terminal-specific DRX on-duration may overlap with each other. In this case, according to the above-described operation, an overlapping period may be considered as an active time from the cell DTX operation perspective, and the overlapping part may be considered as an inactive time from the terminal-specific DRX operation perspective. When the overlapping part is considered as the active time from the cell DTX operation perspective, the terminal may perform PDCCH monitoring in the overlapping part. When the overlapping part is considered as the inactive time from the terminal-specific DRX operation perspective, the terminal may skip PDCCH monitoring in the overlapping part. The above two operations may conflict with each other.

If the cell DTX operation and the terminal-specific DRX operation conflict in a period where on-durations overlap, the terminal may determine which operation is prioritized according to a prioritization rule and perform the preferred operation. In other words, the terminal may perform an operation with high priority. The terminal may not perform an operation with low priority. For example, the cell DTX operation may have higher priority than the terminal-specific DRX operations. Accordingly, the terminal may perform a PDCCH monitoring operation in the period where on-durations overlap. Alternatively, regardless of the priority between the cell DTX operation and the terminal-specific DRX operation, the operation in which the terminal performs PDCCH monitoring may have priority over the operation in which the terminal does not perform PDCCH monitoring. Alternatively, the operation in which the terminal does not perform PDCCH monitoring may have priority over the operation in which the terminal performs PDCCH monitoring.

Alternatively, the terminal may not expect to receive conflicting operation indications for overlapping on-durations. In the above-described embodiment, the terminal may expect that both the first DCI and the second DCI indicate to perform the wake-up operation or that both the first DCI and the second DCI indicate not to perform the wake-up operation.

According to the above-described method, the operation of the terminal may be clearly defined even in the period where on-durations overlap. However, since the above-described method requires transmission of a wake-up signal for each of cell DTX and terminal-specific DRX, DCI signaling overhead and complexity of PDCCH monitoring of the terminal may increase.

As a method to solve the above-described problem, a method of controlling both the cell DTX operation and the terminal-specific DRX operation of the terminal using one wake-up DCI may be considered. The one wake-up DCI may be associated with the operation of either cell DTX or terminal-specific DRX. For example, the terminal may receive a cell DTX wake-up DCI indicating to perform a wake-up operation. Based on the received DCI, the terminal may perform a wake-up operation for a cell DTX on-duration. In addition, the terminal may perform a wake-up operation for a terminal-specific DRX on-duration. The terminal-specific DRX on-duration may include an on-duration associated with the cell DTX on-duration and/or an on-duration that overlaps (e.g., at least partially overlaps) the cell DTX on-duration. On the other hand, the terminal may receive a terminal-specific wake-up DCI indicating to perform a wake-up operation. Based on the received DCI, the terminal may perform a wake-up operation for a terminal-specific DRX on-duration. In addition, the terminal may perform a wake-up operation for a cell DTX on-duration. The cell DTX on-duration may include an on-duration associated with the terminal-specific DRX on-duration and/or an on-duration that overlaps (e.g., at least partially overlaps) with the terminal-specific DRX on-duration.

Alternatively, the above-described wake-up operation may be limited to being applicable only to either cell DTX or terminal-specific DRX. A terminal performing a monitoring operation of a cell DTX wake-up DCI may not monitor a terminal-specific wake-up DCI, and may regard an on-duration of every terminal-specific DRX cycle as an active time. Conversely, a terminal performing a monitoring operation of a terminal-specific DRX wake-up DCI may not monitor a cell DTX wake-up DCI and may regard an on-duration of every cell DTX cycle as an active time.

For low-power operations of the terminal, a receiver of the terminal may have a structure in which a main receiver (or primary receiver) and a low-power wake-up receiver (WUR) are separated. The above-described wake-up signal reception operation of the terminal may be performed by the wake-up receiver, and general reception operations and/or signal processing operations other than the wake-up signal reception operation may be performed by the main receiver. The terminal may activate the main receiver only when a wake-up signal indicating a wake-up operation is successfully received by the wake-up receiver, and may operate the main receiver in a sleep mode the rest of the time. By applying the above-described receiver structure and operation, the effect of reducing power consumption according to the terminal DRX operation can be maximized.

### [Downlink Measurement Method]

A terminal may perform a downlink measurement operation based on received downlink signals. As described above, the downlink measurement operation may include at least one of an RRM measurement operation, RLM measurement operation, CSI measurement operation, or beam quality measurement operation. The downlink signals may include at least one of CSI-RS, TRS, PRS, DM-RS, SSB, or synchronization signal. Downlink measurement metrics or calculated values may include at least one of reference signal received power (RSRP), reference signal received quality (RSRQ), received signal strength indicator (RSSI), SINR, L1-RSRP, L1-SINR, and block error rate (BLER), or hypothetical SINR. The measurement metrics (e.g., downlink measurement metrics) may be calculated by the terminal, and the terminal may report the calculated measurement metrics to the base station. The measurement metrics may be calculated based on one (or one cycle) received signal. Alternatively, the measurement metrics may be calculated based on one or multiple signal(s) transmitted within a measurement window.

As described above, some downlink signals may not be received by the terminal in cell DTX inactive times. For example, the terminal may receive configuration of periodic or semi-persistent downlink signals (e.g., periodic CSI-RS). Periodic CSI-RS resources may include a first CSI-RS resource and a second CSI-RS resource. The first CSI-RS resource and the second CSI-RS resource may belong to different periods. The terminal may receive a CSI-RS in the first CSI-RS resource belonging to a cell DTX active time, and may not receive a CSI-RS in the second CSI-RS resource belonging to a cell DTX inactive time. In this case, the second CSI-RS resource may be excluded from the downlink measurement operation of the terminal described above. For example, the second CSI-RS resource may be included in a measurement window assumed by the terminal. In this case, the terminal may calculate a measurement metric based on CSI-RS(s) received in the remaining CSI-RS resource(s) excluding the second CSI-RS resource.

In other words, the terminal may perform a CSI reporting operation under a certain condition. For example, when the terminal receives at least one valid CSI-RS transmission occasion for CSI reporting, the terminal may perform the CSI reporting operation. The reception of a CSI-RS transmission occasion may refer to reception of a CSI-RS in a CSI-RS resource (e.g., CSI-RS transmission occasion). If a valid CSI-RS transmission occasion for CSI reporting is not received, the terminal may skip the CSI reporting operation. In other words, a CSI report may be dropped. The valid CSI-RS transmission occasion may be a transmission occasion for a periodic or semi-persistent CSI-RS resource. In this case, the valid CSI-RS transmission occasion may be a CSI-RS transmission occasion belonging to a cell DTX active time. A CSI-RS transmission occasion belonging to a cell DTX inactive time may be considered to be invalid in terms of the CSI reporting operation. In addition to the above-described exemplary embodiment, the valid CSI-RS transmission occasion may be a CSI-RS transmission occasion no later than a CSI reference resource. Alternatively, the valid CSI-RS transmission occasion may be a transmission occasion for an aperiodic CSI-RS resource. In this case, the valid CSI-RS transmission occasion may include both a CSI-RS transmission occasion belonging to a cell DTX active time and a CSI-RS transmission occasion belonging to a cell DTX inactive time. In addition to the above-described exemplary embodiment, the valid CSI-RS transmission occasion may be a CSI-RS transmission occasion no later than the CSI reference resource. The terminal may transmit a CSI report corresponding to the valid CSI-RS transmission occasion to the base station only when it receives at least one valid CSI-RS transmission occasion described above. The CSI report may include at least one of a precoding matrix indicator (PMI), a channel quality indicator (CQI), a rank indicator (RI), a CSI-RS resource indicator (CRI), or a layer indicator (LI) as a CSI measurement result. The CSI report may include at least RI. The CSI-RS transmission occasion may belong to a CSI-RS resource configured for the channel measurement operation of the terminal. In addition, the CSI-RS transmission occasion may belong to a CSI-RS resource or CSI-IM resource configured for an interference measurement operation of the terminal.

For another example, the terminal may calculate a measurement metric based on a single received signal, and the measurement metric to be reported to the base station at a certain time may correspond to the second CSI-RS resource. For example, the measurement metric may be CSI (e.g., CQI, PMI, RI, CRI, LI, etc.). In this case, the terminal may skip an operation of calculating CSI corresponding to the second CSI-RS resource. The terminal may not perform an operation of reporting CSI corresponding to the second CSI-RS resource to the base station. When the CSI reporting information is transmitted on a PUCCH (or PUSCH), the terminal may not transmit the PUCCH (or PUSCH). Alternatively, the terminal may transmit the PUCCH (or PUSCH) that does not include the CSI reporting information. Alternatively, the measurement metric (e.g., CSI) corresponding to the second CSI-RS resource may be determined as a predefined value or a dummy value. The terminal may report CSI with the above value (e.g., predefined value or dummy value) to the base station. Additionally or alternatively to the above-described exemplary embodiment, the terminal may determine whether to perform a CSI reporting operation based on the size of CSI corresponding to the second CSI-RS resource. For example, if the size of CSI is less than a reference value, the terminal may report the CSI to the base station. If the size of CSI exceeds the reference value, the terminal may skip the CSI reporting operation.

### [HARQ-ACK Transmission Method]

Transmission of a data channel in the communication system may be performed based on HARQ. In downlink communication, the terminal may feedback HARQ-acknowledgement (ACK) information, which is a result of reception of a scheduled PDSCH, to the base station, and the base station may determine whether to retransmit the corresponding transport block (TB) (e.g., a TB associated with the HARQ-ACK information) based on the HARQ-ACK information received from the terminal. When the terminal successfully receives the PDSCH (e.g., TB), the HARQ-ACK information corresponding to the TB may be ACK. When the terminal does not successfully receive the PDSCH (e.g., TB), the HARQ-ACK information corresponding to the TB may be NACK. The HARQ-ACK information may include only ACK. Alternatively, the HARQ-ACK information may include only NACK. Alternatively, the HARQ-ACK information may include ACK or NACK. HARQ-ACK information corresponding to each downlink TB may be 1 bit. A code block group (CBG)-based HARQ transmission scheme may be used, and one TB may be composed of M CBG(s). M may be a natural number. In this case, M bits of HARQ-ACK information may correspond to each downlink TB.

The terminal may receive, from the base station, an indication or configuration of an uplink resource (e.g., PUCCH resource, PUSCH resource, SRS resource, etc.) to transmit an HARQ-ACK. The terminal may receive, from the base station, an indication or configuration of a time distance (hereinafter referred to as ‘HARQ-ACK timing’) from a reception time of the PDSCH to a transmission time of the HARQ-ACK corresponding to the PDSCH. The terminal may determine an HARQ-ACK feedback time based on the HARQ-ACK timing. Information on the HARQ-ACK timing may be included in DCI and/or SPS configuration information for scheduling the PDSCH. In the present disclosure, an HARQ-ACK may refer to an HARQ-ACK for a dynamically scheduled PDSCH and/or an HARQ-ACK for an SPS PDSCH. Each of a PDSCH reception time and an HARQ-ACK feedback time may mean a slot including the time (e.g., reception time, feedback time). The HARQ-ACK timing may mean a slot offset (e.g., time offset) between the PDSCH and the HARQ-ACK. The slot may be a slot formed based on a numerology of an uplink bandwidth part. Alternatively, the slot may be a slot formed based on a numerology of a downlink bandwidth part. The HARQ-ACK timing may be denoted as K1. In the present disclosure, ‘slot’ is merely an example representing a unit time resource, and ‘slot’ may also be interpreted as other unit time resources such as ‘subslot’ and ‘subframe’.

The terminal may generate an HARQ-ACK codebook including the HARQ-ACK information of the PDSCH and report the HARQ-ACK codebook to the base station. The HARQ-ACK codebook may be configured in a form of an HARQ-ACK codebook with a semi-static size (hereinafter referred to as ‘Type 1 HARQ-ACK codebook’), HARQ-ACK codebook with a dynamic size (hereinafter referred to as ‘Type 2 HARQ-ACK codebook’), or HARQ-ACK codebook to feedback HARQ-ACK(s) for all downlink HARQ processes at once (hereinafter referred to as ‘Type 3 HARQ-ACK codebook’). Each downlink HARQ-ACK may be mapped to each bit constituting a payload of the HARQ-ACK codebook. The size of the HARQ-ACK codebook may be 1 bit or more. The HARQ-ACK codebook may be transmitted to the base station through the above-described uplink resource.

When the base station and the terminal perform cell DRX operations, an uplink operation of the terminal may be limited in a cell DRX inactive time. In this case, a certain resource belonging to the cell DRX inactive time may be determined as a resource for transmitting the HARQ-ACK for the PDSCH. The terminal may skip a transmission operation of the uplink resource (e.g., signal corresponding to the uplink resource). The base station may not be able to receive the HARQ-ACK from the terminal, and it may be difficult to determine whether reception of the PDSCH is successful.

FIG. 12 is a conceptual diagram illustrating a first exemplary embodiment of a PDSCH HARQ-ACK transmission method considering cell DRX operation.

Referring to FIG. 12, a terminal may perform a cell DTX operation and/or a cell DRX operation. The terminal may receive a PDSCH in a cell DTX active time, and may transmit a PUCCH including an HARQ-ACK, which is a reception response of the PDSCH, in a cell DRX active time. The terminal may transmit a first PUCCH including an HARQ-ACK for a first PDSCH, and may transmit a second PUCCH including HARQ-ACKs for a second PDSCH and a third PDSCH. The HARQ-ACKs may be configured in the form of the above-described HARQ-ACK codebook, and encoded HARQ-ACKs (e.g., HARQ-ACK codebook) may be included in the PUCCH.

On the other hand, an HARQ-ACK transmission resource for a fourth PDSCH may be determined as a third PUCCH belonging to a cell DRX inactive time (e.g., a period outside an on-duration). Since the third PUCCH resource (e.g., serving cell, bandwidth part, time period, etc. to which the third PUCCH resource belongs) is inactivated, the terminal may consider the third PUCCH resource as being invalid, and may not transmit the third PUCCH. In other words, the HARQ-ACK for the fourth PDSCH may not be transmitted to the base station. In this case, the terminal receiving the fourth PDSCH without transmitting the HARQ-ACK corresponding to the fourth PDSCH may not be of great help to downlink TB reception performance. Based on this, the terminal may also skip the operation of receiving the fourth PDSCH. The terminal may expect to receive scheduling information for a retransmission PDSCH for the fourth PDSCH from the base station later. According to the above-described method, transmission performance of a TB corresponding to the fourth PDSCH may be degraded and the spectral efficiency may be reduced. Hereinafter, a method for solving the above-mentioned problem will be described.

As a first method, the terminal may not expect a downlink HARQ-ACK transmission resource to be mapped to an invalid resource. Specifically, the terminal may not expect that an HARQ-ACK transmission resource belongs to a cell DRX inactive time or that an HARQ-ACK transmission resource belongs to a cell DRX inactive time, and at the same time, belongs to a signal set for which the terminal skips transmission in the cell DRX inactive time. The base station may prevent an HARQ-ACK transmission resource from being mapped to an invalid resource by appropriately configuring a PDSCH scheduling time, HARQ-ACK timing, cell DRX cycle, and/or cell DRX active times.

As a second method, the terminal may skip an HARQ-ACK reporting operation for at least some PDSCHs. For example, the terminal may skip an HARQ-ACK reporting operation for a PDSCH with invalid HARQ timing due to the cell DRX operation. Then, the base station may transmit to the terminal a separate triggering signal indicating to transmit a downlink HARQ-ACK. The terminal may receive the separate triggering signal from the base station indicating to transmit a downlink HARQ-ACK, and may report an HARQ-ACK that has not been previously transmitted to the base station based on the separate triggering signal. The separate triggering signal may be a downlink scheduling DCI. The downlink scheduling DCI may or may not include PDSCH resource allocation information. Alternatively, the separate triggering signal may be an uplink scheduling DCI or group common DCI.

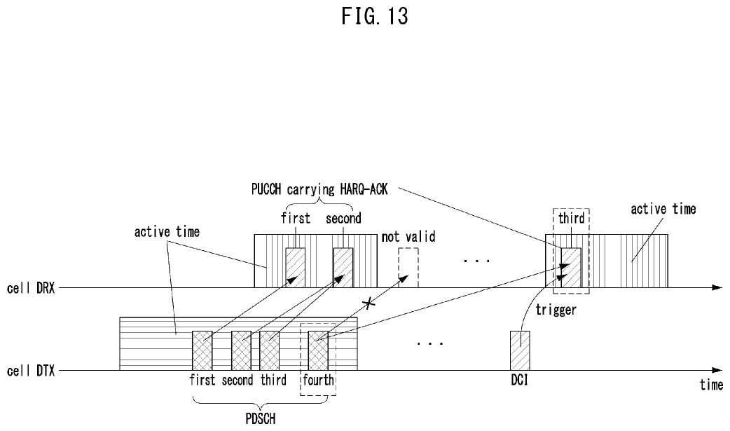

FIG. 13 is a conceptual diagram illustrating a second exemplary embodiment of a PDSCH HARQ-ACK transmission method considering cell DRX operation.

Referring to FIG. 13, first to fourth PDSCHs may be received in a cell DTX active time. A first PUCCH and a second PUCCH, which are HARQ-ACK transmission resources corresponding to the first to third PDSCHs, may be included in the cell DRX active time, and the terminal may transmit HARQ-ACKs (e.g., PUCCHs) for the first to third PDSCHs to the base station. On the other hand, an HARQ-ACK transmission resource initially configured (or indicated) for the fourth PDSCH may be an invalid resource that is not included in the cell DRX active time. The terminal may skip an operation of transmitting the HARQ-ACK for the fourth PDSCH in the non-valid resource (e.g., HARQ-ACK transmission resource). Then, the base station may transmit a DCI that triggers HARQ-ACK transmission to the terminal. The terminal may receive the DCI that triggers HARQ-ACK transmission from the base station, and may transmit the HARQ-ACK for the fourth PDSCH to the base station in the third PUCCH resource based on the received DCI. The third PUCCH resource may be a valid resource included in a cell DRX active time.

For example, the base station may indicate the terminal through the DCI to transmit HARQ-ACKs for all HARQ processes or all HARQ processes held or managed by the terminal in an HARQ buffer. Alternatively, the base station may selectively indicate some HARQ process(s) through the DCI, and indicate the terminal to transmit HARQ-ACK(s) for the some HARQ process(s) indicated through the DCI. Alternatively, the terminal may classify received PDSCHs (e.g., TBs corresponding to the PDSCHs, HARQ-ACKs corresponding to the PDSCHs) into a plurality of PDSCH groups, and may receive a DCI indicating to report HARQ-ACK(s) for all PDSCH(s) included in one or a plurality of PDSCH group(s) among the plurality of PDSCH groups. In the above-described exemplary embodiment, the DCI scheduling the fourth PDSCH may include information indicating to classify the fourth PDSCH into a first PDSCH group, and the terminal may classify the fourth PDSCH into the first PDSCH group based on the indication of the DCI. Then, the terminal may receive a DCI indicating to report an HARQ-ACK for the first PDSCH group, and may transmit an HARQ-ACK for the fourth PDSCH belonging to the first PDSCH group to the base station in the third PUCCH resource according to the indication of the DCI.

As a third method, a rule for determining new HARQ timing or new HARQ-ACK transmission resource for a PDSCH with invalid HARQ timing may be defined.

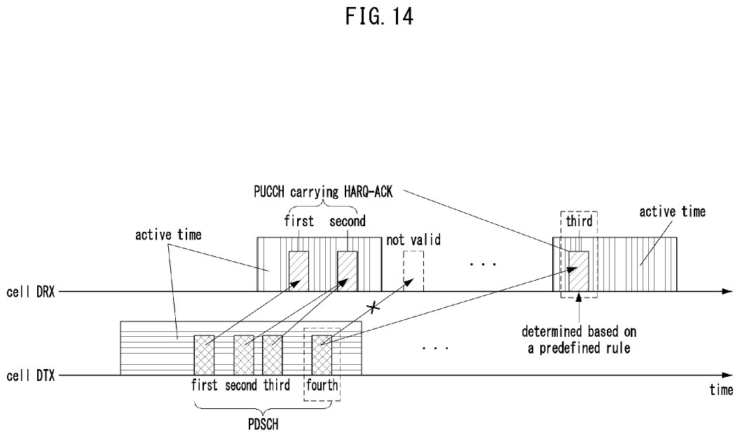

FIG. 14 is a conceptual diagram illustrating a third exemplary embodiment of a PDSCH HARQ-ACK transmission method considering cell DRX operation.

Referring to FIG. 14, in the third exemplary embodiment of FIG. 14, the remaining operations excluding an operation of the terminal transmitting the HARQ-ACK for the fourth PDSCH to the base station may be the same as the second exemplary embodiment of FIG. 13. The terminal may determine a new HARQ-ACK transmission resource or new HARQ timing for the fourth PDSCH based on a rule predefined in technical specifications. The new HARQ-ACK transmission resource may be the third PUCCH. The new HARQ-ACK transmission resource may be a valid uplink resource that appears after the HARQ-ACK transmission resource originally configured in the terminal (e.g., nominal HARQ-ACK transmission resource). The new HARQ-ACK transmission resource may be mapped to a certain one slot (e.g., first appearing slot including a valid PUCCH resource) of a cell DRX active time (e.g., on-duration of the next cell DRX cycle, or a cell DRX active time extended according to the above-described method) that appears after the HARQ-ACK transmission resource originally configured in the terminal. The terminal may transmit the HARQ-ACK for the fourth PDSCH to the base station in the determined uplink resource. According to the above-described method, HARQ-ACK transmission may be deferred, and the deferred HARQ-ACK transmission may be guaranteed by another uplink resource.

As a fourth method, the terminal may consider a slot (or other unit time resources such as subslot, subframe, ms, etc.) to which the HARQ-ACK transmission resource is mapped as an active time, and transmit an HARQ-ACK to the base station in the HARQ-ACK transmission resource.

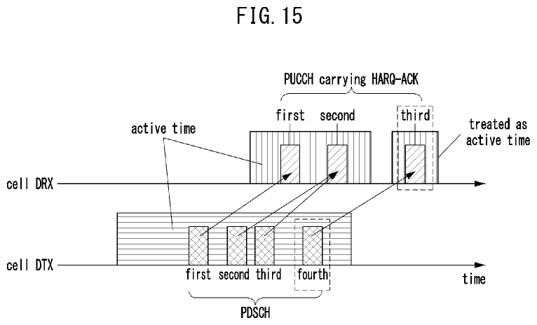

FIG. 15 is a conceptual diagram illustrating a fourth exemplary embodiment of a PDSCH HARQ-ACK transmission method considering cell DRX operation.

Referring to FIG. 15, in the fourth exemplary embodiment of FIG. 15, the remaining operations excluding the operation of the terminal transmitting the HARQ-ACK for the fourth PDSCH to the base station may be the same as the first exemplary embodiment of FIG. 12. The terminal may consider the third PUCCH that is an HARQ-ACK transmission resource corresponding to the fourth PDSCH or a slot (or other unit time resources such as subslot, subframe, ms, etc.) to which the third PUCCH belongs at least as a cell DRX active time. Accordingly, the third PUCCH may be determined to be a valid resource, and the terminal may transmit the HARQ-ACK for the fourth PDSCH to the base station on the third PUCCH.

In the above-described exemplary embodiment, the untransmitted HARQ-ACK may be stored in the terminal's buffer. The terminal may store the HARQ-ACK in the buffer until the terminal transmits the HARQ-ACK to the base station. As a method to reduce the burden on the buffer, the terminal may store the HARQ-ACK in the buffer for a predetermined time and delete the HARQ-ACK from the buffer after the predetermined time. A time during which the HARQ-ACK is stored in the buffer or a time at which the HARQ-ACK is deleted from the buffer may be related to the next transmission opportunity of the HARQ-ACK. For example, the terminal may store the HARQ-ACK in the buffer until a valid PUCCH resource, slot including a valid PUCCH resource, next cell DRX on-duration, active time, etc. appears.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, the method comprising:
receiving cell discontinuous transmission (DTX)/discontinuous reception (DRX) configuration information for serving cells including a first serving cell of a base station;
receiving downlink control information (DCI) including a first field from a second serving cell among the serving cells;
entering a cell DTX inactive time in the first serving cell based on the first field; and
skipping a reception operation of semi-persistent signals in the cell DTX inactive time of the first serving cell.

2. The method of claim 1, further comprising: entering a cell DRX inactive time in the first serving cell based on the first field, wherein a time of entering the cell DRX inactive time is equal to a time of entering the cell DTX inactive time.

3. The method of claim 1, wherein the time of entering the cell DTX inactive time is determined by a timer, and the timer operates periodically based on an information element included in the cell DTX/DRX configuration information.

4. The method of claim 2, wherein the time of entering the cell DRX inactive time is determined by a timer, and the timer operates periodically based on an information element included in the cell DTX/DRX configuration information.

5. The method of claim 1, wherein the semi-persistent signals include a channel state information-reference signal (CSI-RS), and a CSI measurement operation for the CSI-RS is excluded in the cell DTX inactive time.

6. The method of claim 5, wherein CSI that is a result of the CSI measurement operation includes at least a rank indicator (RI).

7. The method of claim 2, further comprising: skipping a transmission operation of semi-persistent signals in the cell DRX inactive time, wherein the semi-persistent signals include at least a configured grant-physical uplink shared channel (CG-PUSCH).

8. The method of claim 1, wherein the first field belongs to an information block configured for the terminal, and a start location of the information block mapped to a payload of the DCI is configured to the terminal in a granularity of 1 bit.

9. The method of claim 1, wherein the DCI further includes information indicating to enter a cell DTX inactive time for another serving cell other than the first serving cell among the serving cells, and the another serving cell belongs to a same cell group as the first serving cell.

10. The method of claim 1, wherein the second serving cell is a primary cell of the terminal.

11. A method of a base station, the method comprising:
transmitting cell discontinuous transmission (DTX)/discontinuous reception (DRX) configuration information for one or more serving cells to a terminal;
transmitting downlink control information (DCI) including a first field to the terminal; and
skipping a transmission operation of semi-persistent signals in a cell DTX inactive time according to the first field.

12. The method of claim 11, further comprising: skipping a reception operation of semi-persistent signals in a cell DRX inactive time according to the first field, wherein a start time of the cell DRX inactive time is equal to a start time of the cell DTX inactive time.

13. The method of claim 11, wherein a start time of the cell DTX inactive time is determined by a timer, and the timer operates periodically based on an information element included in the cell DTX/DRX configuration information.

14. The method of claim 12, wherein a start time of the cell DRX inactive time is determined by a timer, and the timer operates periodically based on an information element included in the cell DTX/DRX configuration information.

15. The method of claim 11, wherein the semi-persistent signals include a channel state information-reference signal (CSI-RS), and a CSI measurement operation for the CSI-RS is excluded in the cell DTX inactive time.

16. The method of claim 12, wherein the semi-persistent signals include at least a configured grant-physical uplink shared channel (CG-PUSCH).

17. The method of claim 11, wherein the first field belongs to an information block configured for the terminal, and a start location of the information block mapped to a payload of the DCI is configured to the terminal in a granularity of 1 bit.

18. A terminal comprising at least one processor, wherein the processor causes the terminal to perform:
receiving cell discontinuous transmission (DTX)/discontinuous reception (DRX) configuration information for serving cells including a first serving cell of a base station;
receiving downlink control information (DCI) including a first field from a second serving cell among the serving cells;
entering a cell DTX inactive time in the first serving cell based on the first field; and
skipping a reception operation of semi-persistent signals in the cell DTX inactive time of the first serving cell.

19. The terminal of claim 18, wherein the processor further causes the terminal to perform: entering a cell DRX inactive time in the first serving cell based on the first field, wherein a time of entering the cell DRX inactive time is equal to a time of entering the cell DTX inactive time.

20. The terminal of claim 18, wherein the semi-persistent signals include a channel state information-reference signal (CSI-RS), and a CSI measurement operation for the CSI-RS is excluded in the cell DTX inactive time.
